(19) United States
(12) Patent Application Publication
(10) Pub. No.: US 2025/0335744 A1
(43) Pub. Date: Oct. 30, 2025

(54) NATURAL LANGUAGE INTERFACE FOR PREDICTIVE MODELS

(71) Applicant: Optum, Inc., Minnetonka, MN (US)

(72) Inventors: Ardavan Saeedi, Jersey City, NJ (US); Joel David Stremmel, Iowa City, IA (US); Eran Halperin, Santa Monica, CA (US); Robert Elliott Tillman, Long Island City, NY (US)

(21) Appl. No.: 18/648,869

(22) Filed: Apr. 29, 2024

(51) Int. Cl. G06N 3/0455

(52) U.S. Cl. CPC G06N 3/0455

(57) ABSTRACT

Various embodiments of the present disclosure provide a natural language interface for predictive models. The techniques may include generating an event risk data object for an entity identifier based on an entity feature dataset associated with the entity identifier, receiving a natural language query for the event risk data object, generating a structured data object from the natural language query that comprises a structured data format associated with a defined application programming interface (API) for an event progression model, generating a simulated event risk data object for the entity identifier using the event progression model, and initiating the performance of a prediction-based action based on the simulated event risk data object.

### BACKGROUND

Various embodiments of the present disclosure address technical challenges related to performing machine learning in a computationally accurate, efficient, and/or consistent manner. Traditionally, machine learning models configured for simulating data trajectories for a particular prediction domain utilize machine learning analysis based on data obtained from one or more data sources. However, such machine learning models are typically ill-suited to accurately, efficiently, and/or consistently perform predictive data analysis for data trajectories outside of the scope of data obtained from the one or more data sources. Additionally, such machine learning models are typically non-interactive and/or require expertise for the particular prediction domain. Various embodiments of the present disclosure make important contributions to traditional machine learning techniques by addressing these technical challenges, among others.

### BRIEF SUMMARY

Various embodiments of the present disclosure provide machine learning techniques to address technical challenges rooted in machine learning technology. To do so, some embodiments of the present disclosure provide a machine learning pipeline that utilizes large language modeling for interacting with a predictive machine learning model. Additionally or alternatively, some embodiments of the present disclosure provide a user interface pipeline that utilizes a specially configured application programming interface (API) to configure optimal interactions, data seeding, and/or feature attributions with respect the predictive machine learning model. In some embodiments of the present disclosure, the predictive machine learning model may be intelligently configured for a domain task, such as event progression predictions for an entity identifier. The resulting data provided by the predictive machine learning model may be contextualized and/or formatted for rendering via an interactive electronic interface rendering. In some embodiments of the present disclosure, an event progression graphical visualization related to output of the predictive machine learning model may be provided. In some embodiments of the present disclosure, the event progression graphical visualization may facilitate interactions, data seeding, and/or feature attributions with respect the predictive machine learning model. In some embodiments, the machine learning pipeline and/or the user interface pipeline of the present disclosure provides improved model interpretability, bias mitigation, parameter tuning, and/or quality of prediction output for a predictive machine learning model. This, in turn, enables improved machine learning that directly addresses technical challenges within the realm of traditional machine learning technology, including a lack of model interactivity and explainability due to the black box nature of traditional machine learning models.

In some embodiments, a computer-implemented method includes generating, by one or more processors and using an event progression model, an event risk data object for an entity identifier based on an entity feature dataset associated with the entity identifier; receiving, by the one or more processors, a natural language query for the event risk data object; generating, by the one or more processors and using a large language model, a structured data object from the natural language query that comprises a structured data format associated with a defined API for the event progression model; generating, by the one or more processors and using the event progression model and the structured data object, a simulated event risk data object for the entity identifier based on (i) a modification to the entity feature dataset or (ii) one or more attention values associated with the event risk data object; and initiating, by the one or more processors, the performance of a prediction-based action based on the simulated event risk data object.

In some embodiments, a computing system comprises memory and one or more processors that are communicatively coupled to the memory, the one or more processors are configured to generate, using an event progression model, an event risk data object for an entity identifier based on an entity feature dataset associated with the entity identifier; receive a natural language query for the event risk data object; generate, using a large language model, a structured data object from the natural language query that comprises a structured data format associated with a defined API for the event progression model; generate, using the event progression model and the structured data object, a simulated event risk data object for the entity identifier based on (i) a modification to the entity feature dataset or (ii) one or more attention values associated with the event risk data object; and initiate the performance of a prediction-based action based on the simulated event risk data object.

In some embodiments, one or more non-transitory computer-readable storage media includes instructions that, when executed by one or more processors, cause the one or more processors to generate, using an event progression model, an event risk data object for an entity identifier based on an entity feature dataset associated with the entity identifier; receive a natural language query for the event risk data object; generate, using a large language model, a structured data object from the natural language query that comprises a structured data format associated with a defined API for the event progression model; generate, using the event progression model and the structured data object, a simulated event risk data object for the entity identifier based on (i) a modification to the entity feature dataset or (ii) one or more attention values associated with the event risk data object; and initiate the performance of a prediction-based action based on the simulated event risk data object.

### BRIEF DESCRIPTION OF THE DRAWINGS

FIG. 1 provides an example overview of an architecture in accordance with one or more embodiments of the present disclosure.

FIG. 2 provides an example predictive data analysis computing entity in accordance with some embodiments of the present disclosure.

FIG. 3 provides an example client computing entity in accordance with one or more embodiments of the present disclosure.

FIG. 4 is an example dataflow diagram showing example data structures, modules, and/or pipelines for generating an event progression graphical visualization in accordance with one or more embodiments discussed herein.

FIG. 5 provides an example dataflow diagram showing example data structures, modules, and/or pipelines for optimizing functionality of an event progression model in accordance with one or more embodiments discussed herein.

FIG. 6 provides an example dataflow diagram showing example data structures, modules, and/or pipelines for optimizing predictive output of an event progression model in accordance with one or more embodiments discussed herein.

FIG. 7 provides an example system for providing prediction-based actions and/or visualizations in accordance with one or more embodiments discussed herein.

FIG. 8 provides an example user interface flow diagram related to a conversational user interface in accordance with one or more embodiments discussed herein.

FIG. 9 provides another example user interface flow diagram related to a conversational user interface in accordance with one or more embodiments discussed herein.

FIG. 10 provides an example conversational user interface in accordance with one or more embodiments discussed herein.

FIG. 11 provides another example conversational user interface in accordance with one or more embodiments discussed herein.

FIG. 12 is a flowchart diagram of an example process for providing a machine learning pipeline in accordance with one or more embodiments discussed herein.

FIG. 13 is a flowchart diagram of an example process for providing a user interface pipeline in accordance with one or more embodiments discussed herein.

### DETAILED DESCRIPTION

Various embodiments of the present disclosure are described more fully hereinafter with reference to the accompanying drawings, in which some, but not all embodiments of the present disclosure are shown. Indeed, the present disclosure may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “example” are used to be examples with no indication of quality level. Terms such as “computing,” “determining,” “generating,” and/or similar words are used herein interchangeably to refer to the creation, modification, or identification of data. Further, “based on,” “based at least in part on,” “based at least on,” “based upon,” and/or similar words are used herein interchangeably in an open-ended manner such that they do not necessarily indicate being based only on or based solely on the referenced element or elements unless so indicated. Like numbers refer to like elements throughout.

### I. COMPUTER PROGRAM PRODUCTS, METHODS, AND COMPUTING ENTITIES

Embodiments of the present disclosure may be implemented in various ways, including as computer program products that comprise articles of manufacture. Such computer program products may include one or more software components including, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as, for example, in a particular directory, folder, or library. Software components may be static (e.g., pre-established, or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

A non-volatile computer-readable storage medium may include a floppy disk, flexible disk, hard disk, solid-state storage (SSS) (e.g., a solid-state drive (SSD), solid-state card (SSC), solid-state module (SSM)), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

A volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present disclosure may also be implemented as methods, apparatus, systems, computing devices, computing entities, and/or the like. As such, embodiments of the present disclosure may take the form of an apparatus, system, computing device, computing entity, and/or the like executing instructions stored on a computer-readable storage medium to perform certain steps or operations. Thus, embodiments of the present disclosure may also take the form of an entirely hardware embodiment, an entirely computer program product embodiment, and/or an embodiment that comprises a combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some example embodiments, retrieval, loading, and/or execution may be performed in parallel such that multiple instructions are retrieved, loaded, and/or executed together. Thus, such embodiments may produce specifically configured machines performing the steps or operations specified in the block diagrams and flowchart illustrations. Accordingly, the block diagrams and flowchart illustrations support various combinations of embodiments for performing the specified instructions, operations, or steps.

### II. EXAMPLE FRAMEWORK

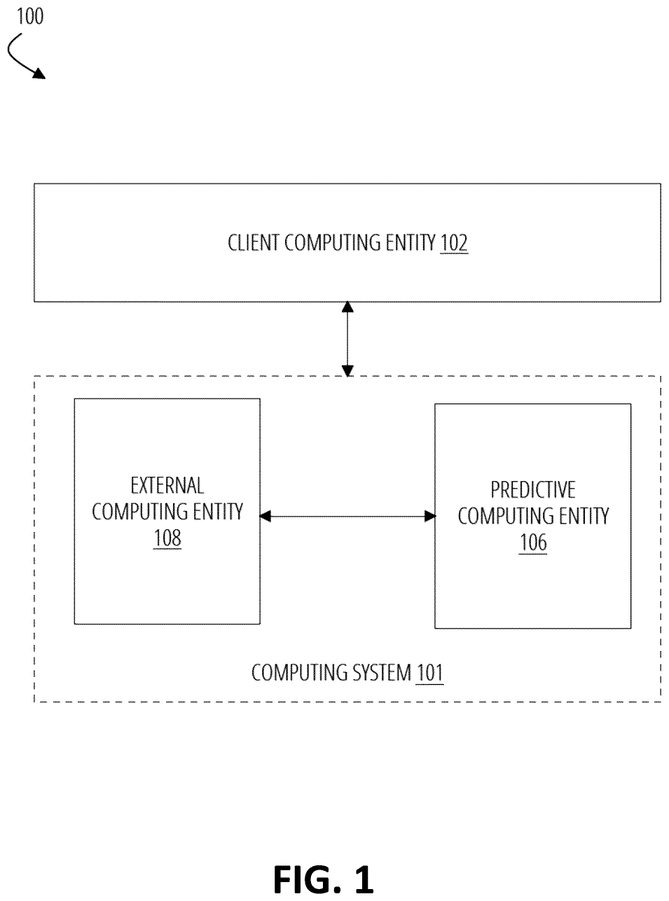

FIG. 1 provides an example overview of an architecture 100 in accordance with some embodiments of the present disclosure. The architecture 100 includes a computing system 101 configured to provide a machine learning pipeline that utilizes large language modeling for interacting with a predictive machine learning model. The architecture 100 includes a computing system 101 configured to provide a user interface pipeline that utilizes a specially configured application programming interface (API) to configure optimal interactions, data seeding, and/or feature attributions with respect the predictive machine learning model. In some embodiments, the machine learning pipeline and/or the user interface pipeline may be utilized to augment and/or transform machine learning input data obtained from one or more data sources. For example, the machine learning pipeline and/or the user interface pipeline may be utilized to improve data quality, data filtering, and/or data ingestion for the predictive machine learning model. In some embodiments, the computing system 101 may be configured to intelligently configure the predictive machine learning model for a data processing task such as, for example, a machine learning task and/or an API task for an electronic interface. In some embodiments, the computing system 101 may be configured to intelligently configure the predictive machine learning model for a particular domain such as, for example, event progression prediction for an entity identifier. The resulting output data provided by the predictive machine learning model may be contextualized and/or formatted for rendering via an interactive electronic interface rendering. In some embodiments, the computing system 101 may be configured to generate an event progression graphical visualization for an entity identifier. The example architecture 100 may be used in a plurality of domains and not limited to any specific application as disclosed herewith. The plurality of domains may include healthcare, banking, industrial, manufacturing, education, retail, enterprise, to name a few.

In some embodiments, the computing system 101 may provide a machine learning pipeline that computes even risk scores for a patient by applying an event progression model to an entity dataset for an entity identifier, provides a visualization via a user interface that renders an initial event progression graphical visualization dashboard based on the event risk scores and predefined event outcome labels, receives natural language queries related to the initial event progression graphical visualization dashboard via the user interface, translates the natural language queries into a structured data format that matches an API for the event progression model, computes simulated event risk scores for the entity identifier by applying the event progression model to the entity dataset and the structured data format associated with the natural language queries, and/or provides an updated visualization via the user interface that renders an updated event progression graphical visualization dashboard based on the simulated event risk scores.

In some embodiments, the computing system 101 may provide a user interface pipeline that receives a user interface API call that indicates an entity dataset and/or an event progression model, receives one or more natural language queries via a conversational user interface for a large language model (LLM), executes an event progression model API configured based on the user interface API and the one or more natural language queries to interact with the event progression model and generate event progression inferences for the entity identifier, and generates a rendering of a set of interactive graphical elements via a user interface based on the event progression inferences.

In accordance with various embodiments of the present disclosure, one or more machine learning models such as, for example, an event progression model, may be trained to generate generative data such as, for example, one or more event risk data objects. The models may form at least a portion of a machine learning pipeline and/or a user interface pipeline that may be configured to automatically generate an event progression graphical visualization. This technique will lead to more accurate and reliable generative modeling techniques that may be efficiently used for a diverse set of different cases.

In some embodiments, the computing system 101 may communicate with at least one of the client computing entities 102 using one or more communication networks. Examples of communication networks include any wired or wireless communication network including, for example, a wired or wireless local area network (LAN), personal area network (PAN), metropolitan area network (MAN), wide area network (WAN), or the like, as well as any hardware, software, and/or firmware required to implement it (such as, e.g., network routers, and/or the like).

The computing system 101 may include a predictive computing entity 106 and one or more external computing entities 108. The predictive computing entity 106 and/or one or more external computing entities 108 may be individually and/or collectively configured to receive requests and/or prompts from client computing entities 102, process the requests and/or prompts to generate outputs, such as generative data objects, and/or the like, and provide the generated data objects and/or a related visualization (e.g., an event progression graphical visualization) to the client computing entities 102. For example, as discussed in further detail herein, the predictive computing entity 106 and/or one or more external computing entities 108 comprise storage subsystems that may be configured to store input data, data objects, training data, and/or the like that may be used by the respective computing entities to perform predictive data analysis, large language modeling, generative modeling, and/or training operations of the present disclosure. In addition, the storage subsystems may be configured to store model definition data used by the respective computing entities to perform various predictive data analysis and/or training tasks. The storage subsystem may include one or more storage units, such as multiple distributed storage units that are connected through a computer network. Each storage unit in the respective computing entities may store at least one of one or more data assets and/or one or more data about the computed properties of one or more data assets. Moreover, each storage unit in the storage systems may include one or more non-volatile storage or memory media including, but not limited to, hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

In some embodiments, the predictive computing entity 106 and/or one or more external computing entities 108 are communicatively coupled using one or more wired and/or wireless communication techniques. The respective computing entities may be specially configured to perform one or more steps/operations of one or more techniques described herein. By way of example, the predictive computing entity 106 may be configured to train, implement, use, update, and evaluate machine learning models in accordance with one or more training and/or inference operations of the present disclosure. In some examples, the external computing entities 108 may be configured to train, implement, use, update, and evaluate machine learning models in accordance with one or more training and/or inference operations of the present disclosure.

In some example embodiments, the predictive computing entity 106 may be configured to receive and/or transmit one or more datasets, objects, and/or the like from and/or to the external computing entities 108 to perform one or more steps/operations of one or more techniques (e.g., generative data object techniques, classification techniques, simulation techniques, and/or the like) described herein. The external computing entities 108, for example, may include and/or be associated with one or more entities that may be configured to receive, transmit, store, manage, and/or facilitate datasets, such as one or more third-party data sources, and/or the like. The external computing entities 108, for example, may include data sources (e.g., third-party data sources) that may provide such datasets, and/or the like to the predictive computing entity 106 which may leverage the datasets to perform one or more steps/operations of the present disclosure, as described herein. In some examples, the datasets may include an aggregation of data from across a plurality of external computing entities 108 into one or more aggregated datasets. The external computing entities 108, for example, may be associated with one or more data repositories, cloud platforms, compute nodes, organizations, and/or the like, which may be individually and/or collectively leveraged by the predictive computing entity 106 to obtain and aggregate data for a prediction domain.

In some example embodiments, the predictive computing entity 106 may be configured to receive a trained machine learning model trained and subsequently provided by the one or more external computing entities 108. For example, the one or more external computing entities 108 may be configured to perform one or more training steps/operations of the present disclosure to train a machine learning model, as described herein. In such a case, the trained machine learning model may be provided to the predictive computing entity 106, which may leverage the trained machine learning model to perform one or more inference and/or generative modeling steps/operations of the present disclosure. In some examples, feedback (e.g., evaluation data, ground truth data, etc.) from the use of the machine learning model may be recorded by the predictive computing entity 106. In some examples, the feedback may be provided to the one or more external computing entities 108 to continuously train the machine learning model over time. In some examples, the feedback may be leveraged by the predictive computing entity 106 to continuously train the machine learning model over time. In this manner, the computing system 101 may perform, via one or more combinations of computing entities, one or more prediction, training, and/or any other machine learning-based techniques of the present disclosure.

### A. Example Computing Entity

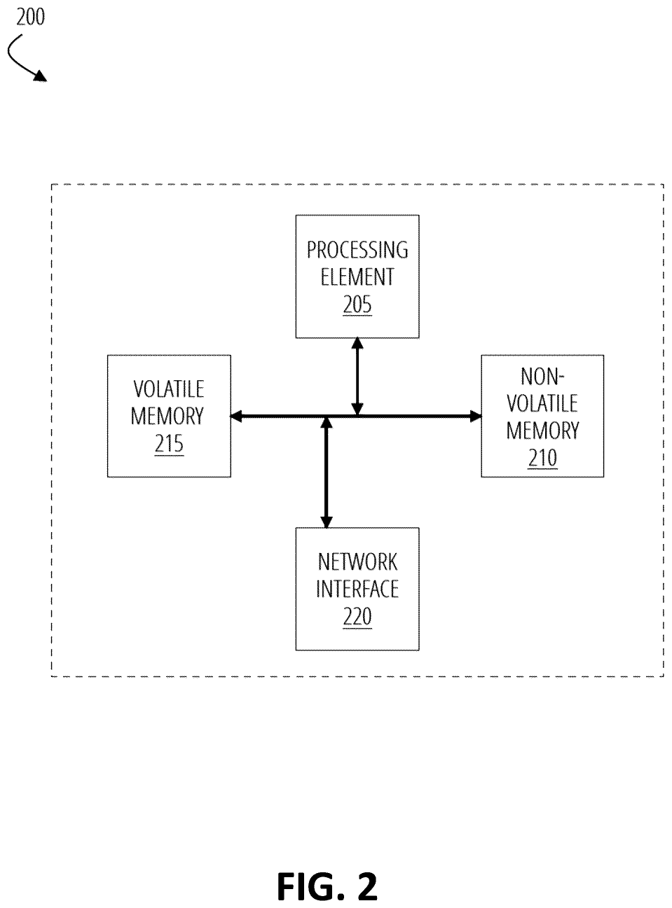

FIG. 2 provides an example computing entity 200 in accordance with some embodiments of the present disclosure. The computing entity 200 is an example of the predictive computing entity 106 and/or external computing entities 108 of FIG. 1. In general, the terms computing entity, computer, entity, device, system, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, training one or more machine learning models, monitoring, evaluating, comparing, and/or similar terms used herein interchangeably. In some embodiments, these functions, operations, and/or processes may be performed on data, content, information, and/or similar terms used herein interchangeably. In some embodiments, the computing entity (e.g., predictive computing entity 106, etc.) may train and use one or more machine learning models described herein. In other embodiments, a first computing entity (e.g., predictive computing entity 106, etc.) may use one or more machine learning models that may be trained by a second computing entity (e.g., external computing entity 108) communicatively coupled to the first computing entity. The second computing entity, for example, may train one or more of the machine learning models described herein, and subsequently provide the trained machine learning model(s) (e.g., optimized weights, code sets, etc.) to the first computing entity over a network.

As shown in FIG. 2, in some embodiments, the computing entity 200 may include, or be in communication with, one or more processing elements 205 (also referred to as processors, processing circuitry, and/or similar terms used herein interchangeably) that communicate with other elements within the computing entity 200 via a bus, for example. As will be understood, the processing element 205 may be embodied in a number of different ways.

For example, the processing element 205 may be embodied as one or more complex programmable logic devices (CPLDs), microprocessors, multi-core processors, coprocessing entities, application-specific instruction-set processors (ASIPs), microcontrollers, and/or controllers. Further, the processing element 205 may be embodied as one or more other processing devices or circuitry. The term circuitry may refer to an entirely hardware embodiment or a combination of hardware and computer program products. Thus, the processing element 205 may be embodied as integrated circuits, application specific integrated circuits (ASICs), field programmable gate arrays (FPGAs), programmable logic arrays (PLAs), hardware accelerators, other circuitry, and/or the like.

As will therefore be understood, the processing element 205 may be configured for a particular use or configured to execute instructions stored in volatile or non-volatile media or otherwise accessible to the processing element 205. As such, whether configured by hardware or computer program products, or by a combination thereof, the processing element 205 may be capable of performing steps or operations according to embodiments of the present disclosure when configured accordingly.

In some embodiments, the computing entity 200 may further include, or be in communication with, non-volatile media (also referred to as non-volatile storage, memory, memory storage, memory circuitry, and/or similar terms used herein interchangeably). In some embodiments, the non-volatile media may include one or more non-volatile memory 210, including, but not limited to, hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

As will be recognized, the non-volatile media may store databases, database instances, database management systems, data, applications, programs, program modules, scripts, code (e.g., source code, object code, byte code, compiled code, interpreted code, machine code, etc.) that embodies one or more machine learning models or other computer functions described herein, executable instructions, and/or the like. The term database, database instance, database management system, and/or similar terms used herein interchangeably, may refer to a collection of records or data that is stored in a computer-readable storage medium using one or more database models; such as a hierarchical database model, network model, relational model, entity-relationship model, object model, document model, semantic model, graph model, and/or the like.

In some embodiments, the computing entity 200 may further include, or be in communication with, volatile media (also referred to as volatile storage, memory, memory storage, memory circuitry, and/or similar terms used herein interchangeably). In some embodiments, the volatile media may also include one or more volatile memory 215, including, but not limited to, RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like.

As will be recognized, the volatile storage or memory media may be used to store at least portions of the databases, database instances, database management systems, data, applications, programs, program modules, code (source code, object code, byte code, compiled code, interpreted code, machine code) that embodies one or more machine learning models or other computer functions described herein, executable instructions, and/or the like being executed by, for example, the processing element 205. Thus, the databases, database instances, database management systems, data, applications, programs, program modules, code (source code, object code, byte code, compiled code, interpreted code, machine code) that embodies one or more machine learning models or other computer functions described herein, executable instructions, and/or the like may be used to control certain aspects of the operation of the computing entity 200 with the assistance of the processing element 205 and operating system.

As indicated, in some embodiments, the computing entity 200 may also include one or more network interfaces 220 for communicating with various computing entities (e.g., the client computing entity 102, external computing entities, etc.), such as by communicating data, code, content, information, and/or similar terms used herein interchangeably that may be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. In some embodiments, the computing entity 200 communicates with another computing entity for uploading or downloading data or code (e.g., data or code that embodies or is otherwise associated with one or more machine learning models). Similarly, the computing entity 200 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

Although not shown, the computing entity 200 may include, or be in communication with, one or more input elements, such as a keyboard input, a mouse input, a touch screen/display input, motion input, movement input, audio input, pointing device input, joystick input, keypad input, and/or the like. The computing entity 200 may also include, or be in communication with, one or more output elements (not shown), such as audio output, video output, screen/display output, motion output, movement output, and/or the like.

### B. Example Client Computing Entity

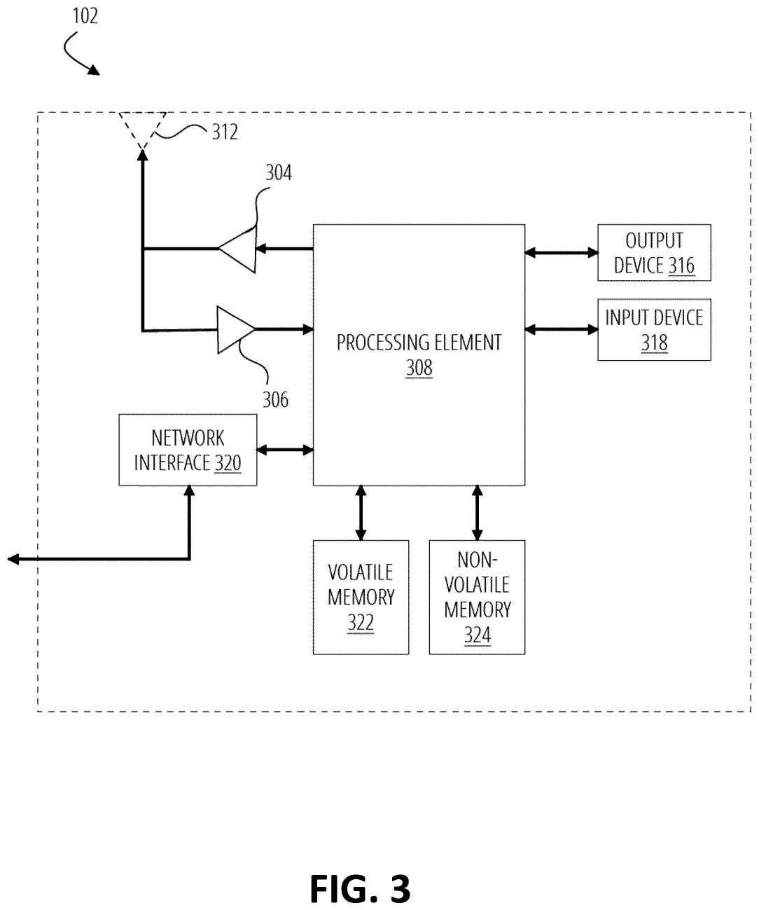

FIG. 3 provides an example client computing entity in accordance with some embodiments of the present disclosure. In general, the terms device, system, computing entity, entity, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Client computing entities 102 may be operated by various parties. As shown in FIG. 3, the client computing entity 102 may include an antenna 312, a transmitter 304 (e.g., radio), a receiver 306 (e.g., radio), and a processing element 308 (e.g., CPLDs, microprocessors, multi-core processors, coprocessing entities, ASIPs, microcontrollers, and/or controllers) that provides signals to and receives signals from the transmitter 304 and receiver 306, correspondingly.

The signals provided to and received from the transmitter 304 and the receiver 306, correspondingly, may include signaling information/data in accordance with air interface standards of applicable wireless systems. In this regard, the client computing entity 102 may be capable of operating with one or more air interface standards, communication protocols, modulation types, and access types. More particularly, the client computing entity 102 may operate in accordance with any of a number of wireless communication standards and protocols, such as those described above with regard to the computing entity 200. In some embodiments, the client computing entity 102 may operate in accordance with multiple wireless communication standards and protocols, such as UMTS, CDMA2000, 1×RTT, WCDMA, GSM, EDGE, TD-SCDMA, LTE, E-UTRAN, EVDO, HSPA, HSDPA, Wi-Fi, Wi-Fi Direct, WiMAX, UWB, IR, NFC, Bluetooth, USB, and/or the like. Similarly, the client computing entity 102 may operate in accordance with multiple wired communication standards and protocols, such as those described above with regard to the computing entity 200 via a network interface 320.

Via these communication standards and protocols, the client computing entity 102 may communicate with various other entities using mechanisms such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). The client computing entity 102 may also download code, changes, add-ons, and updates, for instance, to its firmware, software (e.g., including executable instructions, applications, program modules), and operating system.

According to some embodiments, the client computing entity 102 may include location determining aspects, devices, modules, functionalities, and/or similar words used herein interchangeably. For example, the client computing entity 102 may include outdoor positioning aspects, such as a location module adapted to acquire, for example, latitude, longitude, altitude, geocode, course, direction, heading, speed, universal time (UTC), date, and/or various other information/data. In some embodiments, the location module may acquire data, sometimes known as ephemeris data, by identifying the number of satellites in view and the relative positions of those satellites (e.g., using global positioning systems (GPS)). The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. This data may be collected using a variety of coordinate systems, such as the Decimal Degrees (DD); Degrees, Minutes, Seconds (DMS); Universal Transverse Mercator (UTM); Universal Polar Stereographic (UPS) coordinate systems; and/or the like. Alternatively, the location information/data may be determined by triangulating the position of the client computing entity 102 in connection with a variety of other systems, including cellular towers, Wi-Fi access points, and/or the like. Similarly, the client computing entity 102 may include indoor positioning aspects, such as a location module adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops), and/or the like. For instance, such technologies may include the iBeacons, Gimbal proximity beacons, Bluetooth Low Energy (BLE) transmitters, NFC transmitters, and/or the like. These indoor positioning aspects may be used in a variety of settings to determine the location of someone or something to within inches or centimeters.

The client computing entity 102 may also comprise a user interface (that may include an output device 316 (e.g., display, speaker, tactile instrument, etc.) coupled to a processing element 308) and/or a user input interface (coupled to a processing element 308). For example, the user interface may be a user application, browser, user interface, and/or similar words used herein interchangeably executing on and/or accessible via the client computing entity 102 to interact with and/or cause display of information/data from the computing entity 200, as described herein. The user input interface may comprise any of a plurality of input devices 318 (or interfaces) allowing the client computing entity 102 to receive code and/or data, such as a keypad (hard or soft), a touch display, voice/speech or motion interfaces, or other input device. In some embodiments including a keypad, the keypad may include (or cause display of) the conventional numeric (0-9) and related keys (#, *), and other keys used for operating the client computing entity 102 and may include a full set of alphabetic keys or set of keys that may be activated to provide a full set of alphanumeric keys. In addition to providing input, the user input interface may be used, for example, to activate or deactivate certain functions, such as screen savers and/or sleep modes.

The client computing entity 102 may also include volatile memory 322 and/or non-volatile memory 324, which may be embedded and/or may be removable. For example, the non-volatile memory 324 may be ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. The volatile memory 322 may be RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. The volatile and non-volatile memory may store databases, database instances, database management systems, data, applications, programs, program modules, scripts, code (source code, object code, byte code, compiled code, interpreted code, machine code, etc.) that embodies one or more machine learning models or other computer functions described herein, executable instructions, and/or the like to implement the functions of the client computing entity 102. As indicated, this may include a user application that is resident on the client computing entity 102 or accessible through a browser or other user interface for communicating with the computing entity 200 and/or various other computing entities.

In another embodiment, the client computing entity 102 may include one or more components or functionalities that are the same or similar to those of the computing entity 200, as described in greater detail above. In one such embodiment, the client computing entity 102 downloads, e.g., via network interface 320, code embodying machine learning model(s) from the computing entity 200 so that the client computing entity 102 may run a local instance of the machine learning model(s). As will be recognized, these architectures and descriptions are provided for example purposes only and are not limited to the various embodiments.

In various embodiments, the client computing entity 102 may be embodied as an artificial intelligence (AI) computing entity, such as an Amazon Echo, Amazon Echo Dot, Amazon Show, Google Home, and/or the like. Accordingly, the client computing entity 102 may be configured to provide and/or receive information/data from a user via an input/output mechanism, such as a display, a camera, a speaker, a voice-activated input, and/or the like. In certain embodiments, an AI computing entity may comprise one or more predefined and executable program algorithms stored within an onboard memory storage module, and/or accessible over a network. In various embodiments, the AI computing entity may be configured to retrieve and/or execute one or more of the predefined program algorithms upon the occurrence of a predefined trigger event.

### III. EXAMPLES OF CERTAIN TERMS

In some embodiments, the term “first party” refers to a computing entity that is associated with a processing pipeline. The first party may include a computing system, platform, and/or device that is configured to digest, process, and/or leverage one or more third-party data sources. For example, the first party may include a first-party platform that is configured to digest, process, and/or leverage data from one or more disparate data sources to perform a computing action. In some embodiments, the data from the one or more disparate data sources may be accessible to the first party via a network. In some embodiments, the computing action may include machine learning, data filtering, and/or generating an event progression graphical visualization associated with the data. For example, the first-party platform may include a machine learning processing platform configured to facilitate the performance of one or machine learning models, a data processing platform configured to process, monitor, and/or aggregate large datasets, a user interface platform configured to initiate a rendering of an event progression graphical visualization associated with the data, and/or the like. To improve computing efficiency and enable the aggregation of data across multiple disparate datasets, the first party may utilize one or more first-party data ingestion protocols to generate a defined data object related to the data. For example, the first party may transform third-party data elements from one or more third-party data sources to a defined first-party format to facilitate the machine learning models, data processing, and/or rendering of data associated with the first-party platform. In some examples, the first party may utilize application programming interfaces (APIs) to ingest the data from one or more third-party data sources.

In some embodiments, the term “third-party data source” refers to a data storage entity configured to store, maintain, and/or monitor a data catalog. A third-party data source may include a heterogenous data store that is configured to store a data catalog using specific database technologies. A data store, for example, may include a data repository, such a database, and/or the like, for persistently storing and managing collections of structured and/or unstructured data (e.g., catalogs, etc.). A third-party data source may include an on-premises data store including one or more locally curated data catalogs. In addition, or alternatively, a third-party data source may include a remote data store including one or more cloud-based data lakes. In some examples, a third-party data source may be built on specific database technologies that may be incompatible with one or more other third-party data sources. Each of the third-party data sources may define a data catalog that, in some use cases, may include data segments that could be aggregated to perform a computing task. In some embodiments, a third-party data source may be a health data source. For example, a third-party data source may be an electronic health record data source. In some embodiments, data from a third-party data source may be stored in a particular data formats such as, for example, JSON, XML, FIHR, PDF, and/or another type of data format. In some embodiments, data from a third-party data source may include collection of text data. For example, one or more portions of data from a third-party data source may correspond to a medical record. A medical record may contain information for claim lines in a case. A portion of a medical record for a particular claim line may be one paragraph or a set of keywords in the medical record.

In some embodiments, the term “entity feature dataset” refers to a data entity that describes data from one or more third-party data sources. For example, an entity feature dataset may refer to a data object that includes one or more features associated with one or more third-party data elements from one or more third-party data sources. The entity feature may be formatted according to a defined machine learning input format to facilitate machine learning via one or more models.

In some embodiments, the term “machine learning framework” refers to a data construct that describes parameters, hyperparameters, and/or defined operations of one or more machine learning models configured to generate a prediction output. In some embodiments, a machine learning framework may process data from one or more third-party data sources to provide an event progression graphical visualization related to the data.

Additionally, a machine learning framework may include one or more machine learning models for providing machine learning with respect to the data.

In some embodiments, the term “machine learning model” refers to a data construct that describes parameters, hyperparameters, and/or defined operations configured to generate a prediction output using machine learning techniques. In some embodiments, a machine learning model is configured and/or trained to generate a data object that is formatted to optimize further machine learning, data processing, and/or rendering of data via a user interface. In some embodiments, a machine learning model is trained based on a particular domain task. The machine learning may include one or more of any type of machine learning model including one or more supervised, unsupervised, semi-supervised, reinforcement learning models, and/or the like. In some embodiments, a machine learning model may be configured as a predictive model. In some embodiments, a machine learning model may be configured as a large language model (LLM). An LLM may be a model that is configured, trained, and/or the like to generate natural language data and/or data object related therewith in response to a prompt. The LLM may include any type of LLM, such as a generative pre-trained transformer, and/or the like. Additionally or alternatively, a machine learning model may be configured as a neural network model, a deep learning model, a convolutional neural network (CNN) model, and/or another type of machine learning model related to a particular domain task.

In some embodiments, the term “prediction output” refers to a data construct that describes one or more prediction recommendations, insights, classifications, and/or inferences provided by one or more machine learning models. In various embodiments, prediction recommendations, insights, classifications, and/or inferences may be with respect to an entity feature dataset. In certain embodiments, a prediction output may provide a prediction as to whether a particular event is likely to occur for an entity identifier.

In some embodiments, the term “event progression model” refers to a data construct that describes parameters, hyperparameters, and/or defined operations configured to generate an event risk data object from an entity feature dataset associated with a one or more third-party data elements from one or more third-party data sources. In some embodiments, the event progression model is a predictive machine learning model that is configured, trained, and/or the like to generate one or more predictions and/or inferences associated with one or more predefined events.

In some embodiments, the term “event risk data object” refers to a data entity that describes a machine learning prediction for event risk for respective predefined events. In some embodiments, an event risk data object may indicate a predicted degree of risk for respective events. In some embodiments, an event risk data object may include one or more event risk scores for one or more potential events. An event risk score may provide a predicted risk or probability that a particular event will occur at a future instance in time. In some embodiments, an event may be related to a particular health condition such as, for example, a particular disease.

In some embodiments, the term “entity identifier” refers to a data entity that identifies an entity associated with an entity feature dataset. In some examples, an entity identifier may be determined using information associated with a user device. For example, user device information, network address information, and/or other information included in a header portion, a data segment portion, metadata, or another portion of an entity feature dataset may be correlated to an entity identifier. In some embodiments, an entity identifier is a patient identifier that corresponds to a patient and/or patient information associated with an entity feature dataset (e.g., a patient feature dataset).

In some embodiments, the term “conversational user interface” refers to an electronic interface (e.g., a graphical user interface) of a client computing entity. In some embodiments, the conversational user interface may be configured to emulate a conversation with a human via natural language processing, natural language understanding, and/or one or more other computer processing techniques. In some embodiments, the conversational user interface may be configured to receive an entity feature dataset, an event progression model 402, and/or one or more natural languages queries as input. In some embodiments, the conversational user interface may render an event progression graphical visualization 408 and/or another type of visualization associated with output provided by an event progression model.

In some embodiments, the term “event progression graphical visualization” refers to an interactive rendering that is displayed via a user interface of a user device. In some embodiments, the event progression graphical visualization includes a plurality of interactive graphical elements based on user interactions via the user interface. In some embodiments, the event progression graphical visualization is configured as an event progression timeline chart for providing contextualized event information and/o simulated event information via the user interface. In some embodiments, an event progression timeline chart may include an interactive timeline chart that visualizes predicted information provided by an event progression model in a contextualized manner. In some embodiments, an event progression graphical visualization may allow a user to retrieve detailed information related to predictions and/or events.

In some embodiments, the term “natural language query” refers to a data entity that represents at least a portion of a query or prompt provided to an LLM. In some embodiments, the natural language query is a query data object generated based on real-time activity associated with a user interface. For example, the natural language query may include information provided by a user during one or more interactions with respect to a conversational user interface of a user device. In some embodiments, the real-time activity is a real-time chatbot session associated with an LLM. In some embodiments, the natural language query includes a question or other text. In some embodiments, the natural language query is configured for communication via a network, an API, a machine learning model plug-in, and/or another type of interface between a user device and an LLM.

In some embodiments, the term “structured data object” refers to a data entity that includes a structured data format matching a defined API for an event progression model 402. In some embodiments, a structured data object may be generated by an LLM. In some embodiments, a structured data object may be generated from one or more natural language queries. In some embodiments, the structured data object may be an interactive data object associated with structured programming for a predictive model such as, for example, an event progression model.

In some embodiments, the term “structured data format” refers to a data construct for an API and/or a data object. In some embodiments, the structured data format enables an interaction between one or more natural language queries and a predictive model such as, for example, an event progression model. In some embodiments, the structured data format is formatted according to a set of architectural constraints, rules, and/or protocols for an API. In some embodiments, the structured data format may correspond to a format for an interactive data object such as, for example, the structured data object.

In some embodiments, the term “simulated event risk data object” refers to a data entity that describes a simulated machine learning prediction for event risk for respective predefined events. In some embodiments, a simulated event risk data object may indicate a simulated degree of risk for respective events. In some embodiments, a simulated event risk data object may include one or more simulated event risk scores for one or more simulated events. In some embodiments, a simulated event may be related to a particular health condition such as, for example, a particular disease.

In some embodiments, the term “user interface API request” refers to a data entity that describes a request generated via an API associated with a user interface. In some embodiments, a user interface API request indicates an entity feature dataset and/or an event progression model.

In some embodiments, the term “interactive graphical element” refers to a formatted version of an event risk data object and/or a simulated event risk data object to provide a visualization and/or human interpretation of data associated with the event risk data object and/or the simulated event risk data object via a user interface. In some embodiments, an interactive graphical element may additionally or alternatively be formatted based on an API protocol, user interface container rules, widget specifications, the like, or combinations thereof. In one or more embodiments, an interactive graphical element may include one or more graphical elements and/or one or more textual elements that may be selectable and/or otherwise interacted with via a user interface.

### IV. OVERVIEW

Various embodiments of the present disclosure provide improved data ingestion and machine learning techniques to specifically address technical challenges rooted in machine learning technology. In traditional machine learning pipelines, conventional, black box machine learning models may be accessed to derive outputs based on input information. The outputs may be derived by applying a plurality of learned weights to the input information in a manner that is traditionally not interpretable to a human. Thus, while traditional machine learning pipelines may excel at deriving accurate predictions, classifications, and other insights, they fail to provide the contextual information, such as counterfactual insights, necessary to validate or most efficiently leverage the machine learning outputs. The lack of machine learning model interpretability is traditionally addressed by manually modifying the input information or programmatically modifying the weights of the model to test counterfactual scenarios. These techniques, however, require a combination of model programming and subject matter expertise, are model specific and not generalizable to different model architectures, and lack the adaptability to intelligently diagnose or create counterfactual scenarios based on real world circumstances. Some embodiments of the present disclosure provide improved user and model interfacing mechanisms for addressing these technical deficiencies and, in turn, improve machine learning technology.

To do so, some embodiments of the present disclosure provide an interfacing mechanism (e.g., a new machine learning pipeline, etc.) that utilizes a specifically designed LLM to facilitate new interaction between a user and a predictive machine learning model. In some embodiments, the interfacing mechanism may be supported by a specially designed user interface to provide a user to model interface that converts natural language text from a user to structured model instructions. The model instructions, for example, may leverage a specially configured API that optimizes interactions, data seeding, feature attributions, and/or parameter configurations with respect to the predictive machine learning model. In some embodiments, the interfacing mechanism and the user interface may leverage a new machine learning pipeline to augment and/or transform machine learning input data obtained from one or more data sources based on natural language input. These operations may be performed to adaptively optimize accuracy and efficiency of machine learning model outputs based on real time information. Moreover, the operations may enable new model capabilities for simulating data trajectories outside of the scope of recorded data (e.g., counter factual scenarios, etc.). In some embodiments of the present disclosure, the user interface may integrate insights from the new machine learning model pipeline to present an event progression graphical visualization related to the predictive outputs of a predictive machine learning model. By doing so, the user interface may facilitate further natural language input for validating and/or otherwise interacting with the predictive outputs of the predictive machine learning model. This, in turn, enables improved data ingestion and/or machine learning techniques that directly address technical challenges within the realm of machine learning technology, such as inaccuracies, inefficiencies, and/or limited capability for performing predictive data analysis for particular datasets.

As described herein, machine learning models, like other software components, require specifically formatted inputs (e.g., instructions to perform an action, input data, etc.) that are recognized by the model. To ensure a properly formatted data object for the predictive machine learning model, some embodiments of the present disclosure provide a machine learning process that leverages natural language queries and/or an LLM to optimally configure formatting and structure content for one or more data objects provided as input to the predictive machine learning model. As described herein, the specific data processing and machine learning techniques leveraged for generating one or more data objects enable the predictive machine learning to perform a particular predictive task that is traditionally unachievable and/or error prone using traditional machine learning. In this manner, one or more data objects may be generated using a transformation of natural language queries obtained from a user interface into a data object that satisfies API formatting requirements for the predictive machine learning model such that the data object may be automatically provided as input into the predictive machine learning model. This, in turn, enables an improved machine learning model that directly addresses technical challenges within the realm of traditional machine learning, such as inaccuracies, inefficiencies, and/or limited capability for performing predictive data analysis for particular datasets.

In a non-limiting example related to a healthcare technology domain, various embodiments disclosed herein provide an improvement to traditional machine learning related to patient information stored in electronic health records. For example, traditional machine learning of a healthcare computing system typically encounter several challenges for analyzing patient information from electronic health records, including a static and/or limited input data set for machine learning, interpretability challenges regarding predictive insights provided by the machine learning, etc.

Various embodiments disclosed herein therefore address the technical problems of traditional machine learning of a healthcare computing system to provide a machine learning framework for interpreting machine learning models such as, for example, event progression models, interactively through a user-interface. With the machine learning pipeline disclosed herein, improved interpretability of machine learning predictions and/or dynamic visual presentation of medical information may be provided to improve patient assessment and care provision. In some embodiments, the visual presentation of medical information may be configured as one or more dynamic dashboards for rendering a human-interpretable rendering of machine learning outputs via a user interface.

Examples of technologically advantageous embodiments of the present disclosure include: (i) machine learning techniques such as, for example, feature attribution techniques for improving machine learning predictions provided by machine learning models, (ii) machine learning techniques for optimizing a data object for a rendering of an event progression graphical visualization via a user interface, (iii) improved machine learning models, and training techniques thereof, for generating data objects, and (iv) optimizing a predictive machine learning model based on natural language queries, among other aspects of the present disclosure. Other technical improvements and advantages may be realized by one of ordinary skill in the art.

### V. EXAMPLE SYSTEM OPERATIONS

As indicated, various embodiments of the present disclosure make important technical contributions to data processing and/or machine learning techniques. In particular, systems and methods are disclosed herein that implement machine learning techniques to improve data processing performance with respect to particular computing tasks. By doing so, generative data objects may be improved to expand the applicability of data processing techniques to task-specific use cases related to a contextualized task-specific graphical visualization. In some embodiments, the use of machine learning models may be configured for optimized data processing that is traditionally outside the scope of such models therefore resulting in an improvement to machine learning that is practically applied herein to address technical challenges with aggregating fragmented data across different data sources.

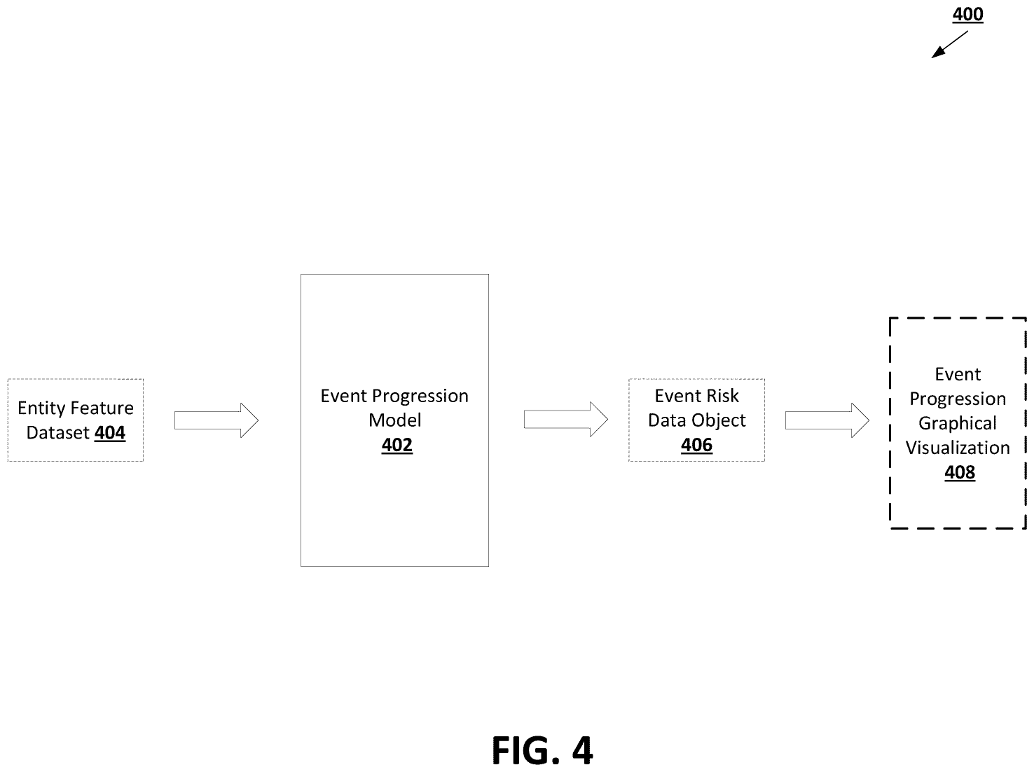

FIG. 4 is a dataflow diagram 400 showing example data structures, modules, and/or pipelines for generating an event progression graphical visualization in accordance with some embodiments discussed herein. The dataflow diagram 400 includes an event progression model 402 configured for providing predictive insights for particular events related to an entity feature dataset 404. In some embodiments, the entity feature dataset 404 includes a data structure format that correspond to a set of input rules and/or requirements for machine learning via the event progression model 402. In some embodiments, the entity feature dataset 404 includes one or more features related to entity-specific information for the entity identifier. The one or more features may be, for example, one or more entity features associated with the entity identifier. Additionally, the entity feature dataset 404 may include one or more features extracted from data stored in one or more third-party data sources. In some embodiments, the one or more third-party data sources are configured as one or more electronic health record data source. In some embodiments, the one or more third-party data sources may store a plurality of third-party data elements. In some embodiments, a third-party data element may correspond to text and/or one or more images. In some embodiments, a third-party data element may be configured in a particular data format such as, for example, PDF, JSON, XML, FHIR, JPEG, DICOM, PNG, TIFF, BMP, and/or another type of data format. In some embodiments, a third-party data element may correspond to at least a portion of an electronic health record. In some embodiments, a least a portion of the entity feature dataset 404 may be generated via an extract-transform-load (ETL) process. In some embodiments, a least a portion of the entity feature dataset 404 may be generated via Object Character Recognition (OCR) to extract textual information from the plurality of third-party data elements. Additionally, the entity feature dataset 404 may be associated with an entity identifier. The entity identifier may correspond to user associated with the plurality of third-party data elements. In some embodiments, the entity identifier may correspond to a patient associated with one or more electronic health records.

In some embodiments, the event progression model 402 generates an event risk data object 406 for the entity identifier based on the entity feature dataset 404. For example, based on the entity feature dataset 404, the event progression model 402 may perform one or more machine learning processes to generate the event risk data object 406. In some embodiments, the event risk data object 406 may indicate a predicted degree of risk for respective events. For example, the event risk data object 406 may include one or more event risk scores for one or more potential events. An event risk score may provide a predicted risk or probability that a particular event will occur at a future instance in time for an entity identifier. In some embodiments, an event may be related to a particular health condition such as, for example, a particular disease. In some embodiments, event risk score may be a disease risk score that provides a predicted risk or probability that a particular disease or other health condition will occur at a future instance in time for a patient identifier.

In some embodiments, an event progression graphical visualization 408 is generated based on the event risk data object 406 provided by the event progression model 402. For example, the event progression graphical visualization 408 may be based on the event risk data object 406 and may include a set of interactive graphical elements for rendering visual data related to the event risk data object 406. In some embodiments, the set of interactive graphical elements may include information corresponding to respective event risk scores for respective events. A rendering of the event progression graphical visualization 408 may be initiated via a user interface.

In some embodiments, the event progression graphical visualization 408 may include an event progression model explainer dashboard. For example, the event progression model explainer dashboard may be an initial event progression model explainer that includes performance information and/or other overview statistics for the event progression model 402. In some embodiments, the event progression model explainer dashboard may include text and/or plots related to the event risk scores and/or predefined event outcome labels for particular events. In some embodiments, the event progression model explainer dashboard includes text and/or plots related to the disease risk scores and predefined disease outcome labels for health condition events. In some embodiments, the event progression graphical visualization 408 may allow a user via a user interface to retrieve detailed information related to predictions for a particular event such as, for example, numerical values, risk scores, predicted event dates and/or times, event descriptions, a predicted likelihood of an event occurring, etc.

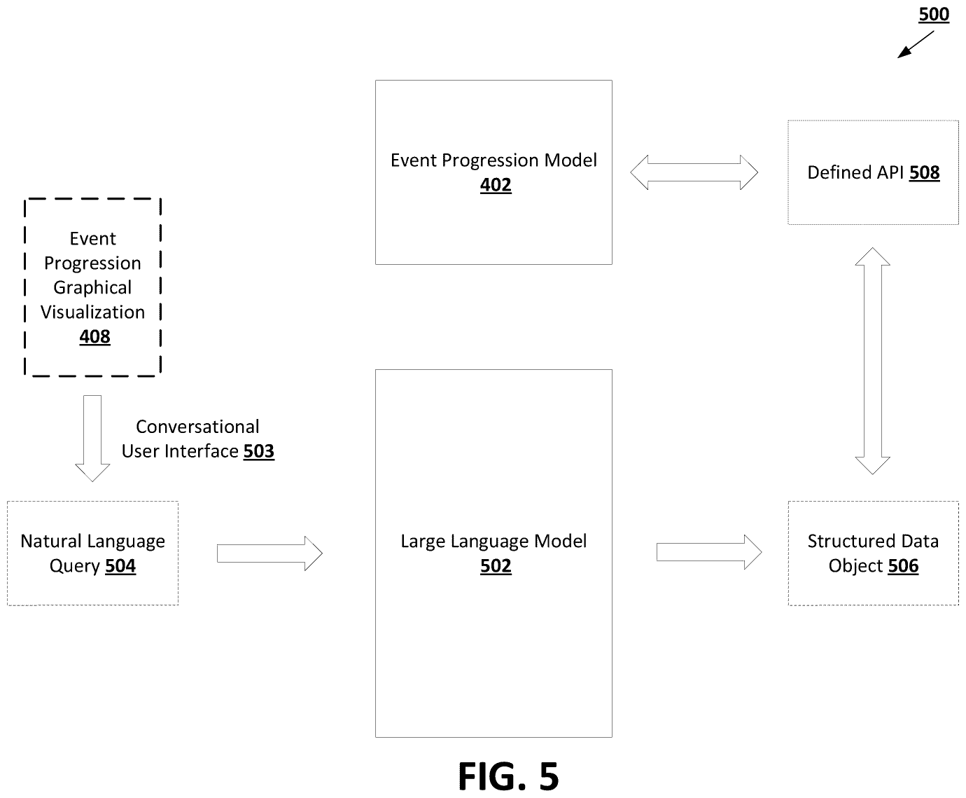

FIG. 5 is a dataflow diagram 500 showing example data structures, modules, and/or pipelines for optimizing functionality of an event progression model in accordance with some embodiments discussed herein. The dataflow diagram 500 includes a large language model 502. The large language model 502 may be utilized to optimize the event progression model 402. In some embodiments, the large language model 502 may be utilized to extend functionality of the event progression model 402.

In some embodiments, the event progression graphical visualization 408 may include a conversational user interface 503 for the large language model 502. The conversational user interface 503 may be configured to receive at least a natural language query 504. The natural language query 504 may be a structured and/or natural language sequence of text (e.g., one or more alphanumeric characters, symbols, etc.). In some examples, the natural language query 504 may include (i) a natural language sequence of text that expresses a question, preference, predictive task, and/or the like and/or (ii) one or more contextual query attributes for constraining a result for the natural language sequence of text. In some embodiments, the natural language query 504 may include a natural language sequence of text to express a question, preference, predictive task, and/or the like for an event that may enhance a prediction provided by the event progression model 402 for addressing the event for an entity identifier. In some embodiments, the natural language query 504 for a clinical domain may include a natural language sequence of text to express a question, preference, predictive task, and/or the like for a medical condition that may enhance a prediction provided by the event progression model 402 for addressing the medical condition for a patient.

In some embodiments, the large language model 502 generates a structured data object 506 based on the natural language query 504. The structured data object 506 may include a structured data format matching a defined API 508 for the event progression model 402. In some embodiments, the structured data object 506 may include a set of computer instructions for interacting with the event progression model 402. In some embodiments, the set of computer instructions may be configured based on the defined API 508. In some embodiments, the large language model 502 may be a GPT model or another type of large language model configured to generate a structured data object from one or more natural language queries.

In some embodiments, the natural language query 504 may be input to the large language model 502 to generate the structured data object 506 by translating the natural language query 504 into the structured data object 506. In some embodiments, the natural language query 504 may be translated into the structured data object 506 by executing a read-evaluate-print (REPL) loop based on the natural language query 504. The REPL loop may be an interactive process associated with the large language model 502. For example, the REPL loop may provide an interface to receive the natural language query 504 and interact with the large language model 502. In some embodiments, the REPL loop may evaluate the natural language query 504 according to a set of rules related to natural language processing and/or natural language understanding for the large language model 502. In some embodiments, the REPL loop may utilize a user interface workflow associated with the event progression graphical visualization 408. For example, the user interface workflow may be an interactive visualization rendered via a user interface of a user device to allow input of the natural language query 504. In some embodiments, the REPL loop may be associated with a real-time chat session via the user interface.

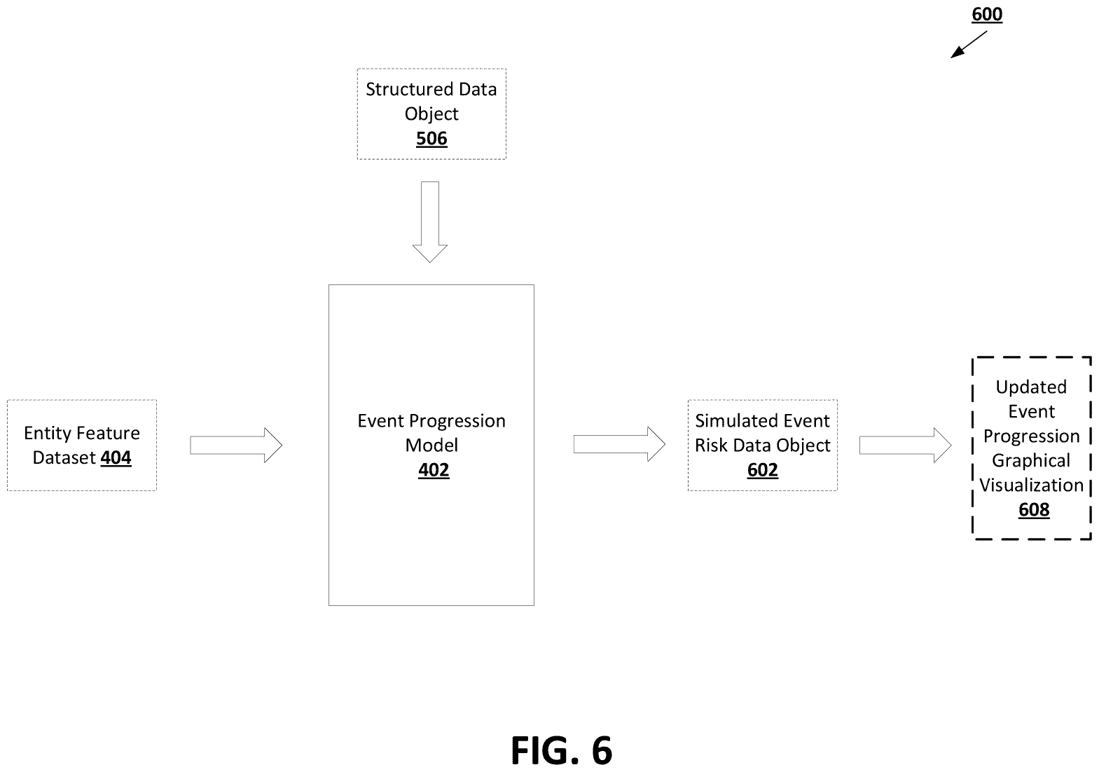

FIG. 6 is a dataflow diagram 600 showing example data structures, modules, and/or pipelines for optimizing predictive output of an event progression model in accordance with some embodiments discussed herein. The dataflow diagram 600 includes the event progression model 402. In some embodiments, the event progression model 402 generates a simulated event risk data object 602 for the entity identifier based on the entity feature dataset 404 and the structured data object 506. For example, based on the entity feature dataset 404 and the structured data object 506, the event progression model 402 may perform one or more machine learning processes to generate the simulated event risk data object 602. In some embodiments, the simulated event risk data object 602 may be a modified version of the event risk data object 406 that simulates one or more alternate trajectories for one or more events related to the event risk data object 406. In some embodiments, the simulated event risk data object 602 may include one or more attention values associated with the event risk data object 406. The one or more attention values may respectively assign a weight to one or more features of the event risk data object 406 based on determined relevance to the natural language query 504. In some embodiments, the simulated event risk data object 602 may indicate a simulated degree of risk for respective events. For example, the simulated event risk data object 602 may include one or more simulated event risk scores for one or more simulated events. In some embodiments, a simulated event may be related to a particular health condition such as, for example, a particular disease.

In some embodiments, responsive to the structured data object 506, the event progression model 402 generates the simulated event risk data object 602 for the entity identifier. In some embodiments, responsive to the structured data object 506, the event progression model 402 generates the simulated event risk data object 602 based on a modification to the entity feature dataset 404. For example, a modified entity feature dataset may be generated by modifying one or more features of the entity feature dataset 404 based on the structured data object 506. A modification to the entity feature dataset 404 and/or one or more features of the entity feature dataset 404 may include removal, addition, weighting, and/or another type of modification to one or more features included in the entity feature dataset 404. For example, one or more features may be removed from the entity feature dataset 404 based on the structured data object 506. In some embodiments, removed features may be determined based on content of the natural language query 504. In some embodiments, the modified entity feature dataset may be input to the event progression model 402 to generate the simulated risk data object 602.

In some embodiments, an event risk score for the entity identifier may be generated based on a sequence of removal of the one or more features from the entity feature dataset 404. In some embodiments, the simulated event risk data object 602 may include the event risk score associated with the sequence of removal of the one or more features from the entity feature dataset 404. In some embodiments, a particular feature from the entity feature dataset 404 may be modified in response to a determination, based on the structured data object 506, that a modification to the particular feature results in a greatest change to the event risk data object 406 as compared to one or more other features from the entity feature dataset 404.

In some embodiments, a simulated entity feature dataset is generated by adding one or more simulated event features to the entity feature dataset 404 based on the structured data object 506. The one or more simulated event features may be related to a simulated trajectory for one or more events. For example, the one or more simulated event features may be one or more synthetic event features that are artificially generated based on the natural language query 504. Additionally, the one or more simulated event features may be determined based on content of the natural language query 504. In some embodiments, an event risk score for the entity identifier may be generated based on the simulated entity feature dataset. In some embodiments, the simulated event risk data object 602 may include the event risk score associated with the simulated entity feature dataset.

In some embodiments, responsive to the structured data object 506, the event progression model 402 additionally or alternatively generates the simulated event risk data object 602 based on one or more attention values associated with the event risk data object 406. The one or more attention values may be one or more weights for one or more features of the event risk data object 406. In some embodiments, the one or more attention values are determined based on a deep learning attention mechanism of the event progression model 402 and/or another machine learning model communicatively coupled to the event progression model 402. In some embodiments, importance of respective features of the entity feature dataset 406 may be determined based on the structured data object 506. For example, importance of respective features of the entity feature dataset 406 with respect to an event progression goal may be determined based on content of the natural language query 504. In some embodiments, the one or more attention values may be determined based on the determined importance of respective features of the entity feature dataset 406. For example, the one or more attention values may be generated based on the importance of respective features. Additionally, a weighted entity feature dataset may be generated by weighting the entity feature dataset 406 based on the importance of respective features. For example, a weighted entity feature dataset may be generated by weighting the entity feature dataset 406 based on the one or more attention values. In some embodiments, the event progression model 402 may generate the simulated event risk data object 602 based on the weighted entity feature dataset associated with the one or more attention values.

In some embodiments, an updated event progression graphical visualization 608 is initiated initiating via the conversational user interface based on the simulated event risk data object 602. The updated event progression graphical visualization 608 may be an updated rendering of the event progression graphical visualization 408 that is based on the simulated event risk data object 602. In some embodiments, the updated event progression graphical visualization 608 may include one or more new and/or updated interactive graphical elements for rendering visual data related to the simulated event risk data object 602. In some embodiments, one or more new and/or updated interactive graphical elements may include information corresponding to one or more updated event risk scores for one or more events. A rendering of the updated event progression graphical visualization 608 may be initiated via a user interface.

In some embodiments, the updated event progression graphical visualization 608 may include an updated event progression model explainer dashboard. For example, the updated event progression model explainer dashboard may include updated information with respect to the initial event progression model explainer. In some embodiments, the updated event progression model explainer dashboard may include updated performance information and/or updated overview statistics for the event progression model 402. In some embodiments, the updated event progression model explainer dashboard may include updated text and/or updated plots related to updated event risk scores and/or updated event outcome labels for particular events. In some embodiments, the updated event progression model explainer dashboard includes updated text and/or updated plots related to updated disease risk scores and/or updated disease outcome labels for health condition events. In some embodiments, the updated event progression graphical visualization 608 may allow a user via a user interface to retrieve updated information related to predictions for a particular event such as, for example, updated numerical values, risk scores, updated predicted event dates and/or times, updated event descriptions, an updated predicted likelihood of an event occurring, etc.

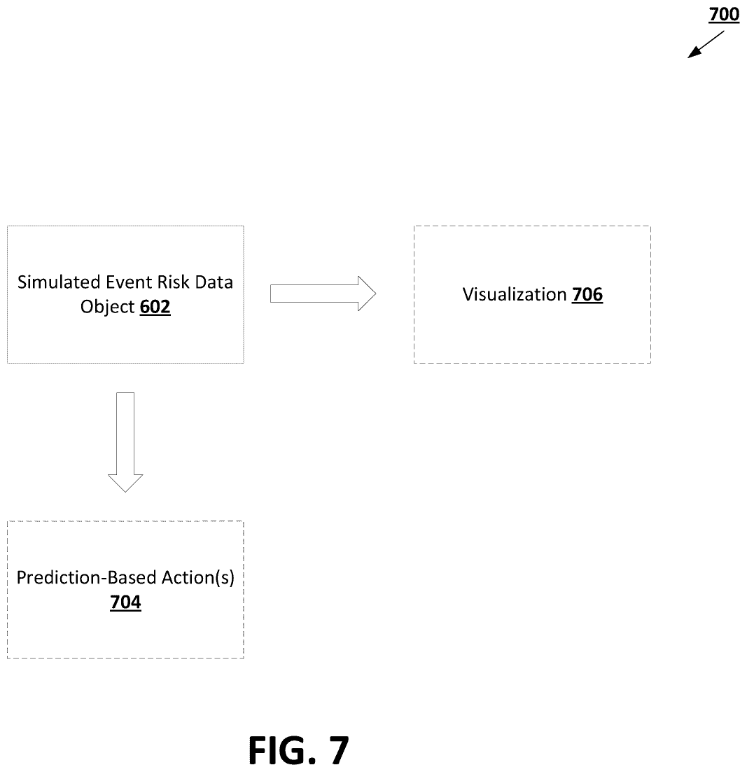

FIG. 7 illustrates an example system 700 for providing prediction-based actions and/or visualizations, in accordance with one or more embodiments of the present disclosure. The system 700 includes the simulated event risk data object 602 provided by the event progression model 402. In one or more embodiments, one or more prediction-based actions 704 are performed based on the simulated event risk data object 602. For example, the performance of the one or more prediction-based actions 704 may be initiated based on the simulated event risk data object 602. In some embodiments, data associated with the simulated event risk data object 602 may be stored in a storage system, such as the volatile memory 215, the non-volatile memory 210, the volatile memory 322, or the non-volatile memory 324. The data stored in the storage system may be employed for providing user interface renderings, event progression graphical visualizations, recommendations, reporting, decision-making purposes, operations management, healthcare management, and/or other purposes. In certain embodiments, the data stored in the storage system may be employed to provide one or more insights to assist with healthcare decision making processes, such as, medical decisions for a patient. Additionally or alternatively, the event progression model 402 may be retrained based on one or more features associated with the simulated event risk data object 602. For example, one or more relationships between features mapped in the event progression model 402 may be adjusted (e.g., refitted) based on data associated with the simulated event risk data object 602. In another example, cross-validation, hyperparameter optimization, and/or regularization associated with the event progression model 402 may be adjusted based on one or more features associated with the simulated event risk data object 602. Additionally or alternatively, a visualization 706 may be generated based on the simulated event risk data object 602. The visualization 706 may include, for example, one or more selectable graphical elements for a user interface (e.g., an electronic interface of a user device) based on the simulated event risk data object 602. In some examples, the visualization 706 may correspond to the updated event progression graphical visualization 608.

In some embodiments, the one or more prediction-based actions 704 may include automated user interface actions, automated alerts, automated instructions to user devices, and/or automated adjustments to allocations of computing resources. Further, the one or more prediction-based actions 704 may include automated physician notification actions, automated patient notification actions, automated appointment scheduling actions, automated prescription recommendation actions, automated record updating actions, automated datastore updating actions, automated workforce management operational management actions, automated server load balancing actions, automated resource allocation actions, automated pricing actions, automated plan update actions, automated alert generation actions, generating one or more electronic communications, and/or the like. The one or more prediction-based actions 704 may further include displaying visual renderings of the aforementioned examples of prediction-based actions in addition to values, charts, and representations associated with the one or more policy scores and the prediction output using a prediction output user interface such as, for example, the visualization 706.

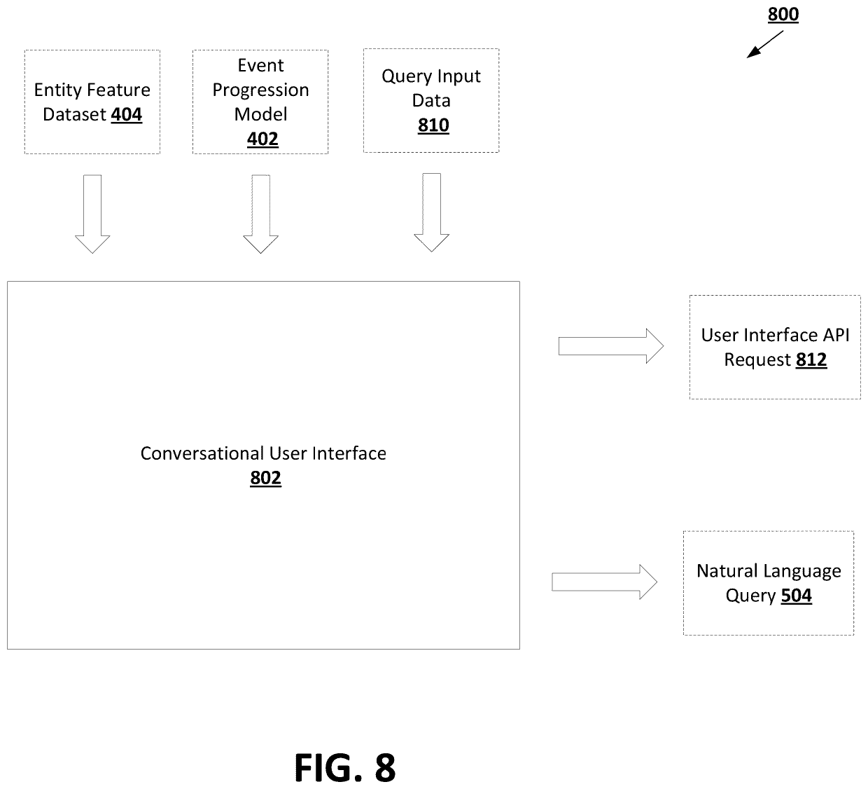

FIG. 8 illustrates an example user interface flow diagram 800 related to a conversational user interface, in accordance with one or more embodiments of the present disclosure. In one or more embodiments, the user interface flow diagram 800 includes a conversational user interface 802. The conversational user interface 802 is, for example, an electronic interface (e.g., a graphical user interface) of the client computing entity 102. In various embodiments, the conversational user interface 802 may be provided via the output device 316 of the client computing entity 102. The conversational user interface 802 may be configured to emulate a conversation with a human via natural language processing, natural language understanding, and/or one or more other computer processing techniques. In some embodiments, the conversational user interface 802 may be configured to receive the entity feature dataset 404, the event progression model 402, and/or query input data 810 as input. In some embodiments, the query input data 810 may include one or more natural language queries (e.g., the natural language query 504) provided by a user. Additionally, the conversational user interface 802 may be configured to output one or more natural language queries (e.g., the natural language query 504) and/or a user interface API request 812. In some embodiments, the user interface API request 812 may indicate the entity feature dataset 404 and/or the event progression model 402 provided as input to the conversational user interface 802. In some embodiments, the conversational user interface 802 may render the event progression graphical visualization 408, the updated event progression graphical visualization 608, and/or the visualization 706. For example, the conversational user interface 802 may render one or more graphical elements related to the event progression graphical visualization 408, the updated event progression graphical visualization 608, and/or the visualization 706. In some embodiments, the conversational user interface 802 may be configured as a web portal interface (e.g., a medical diagnosis portal, etc.) or an application interface.

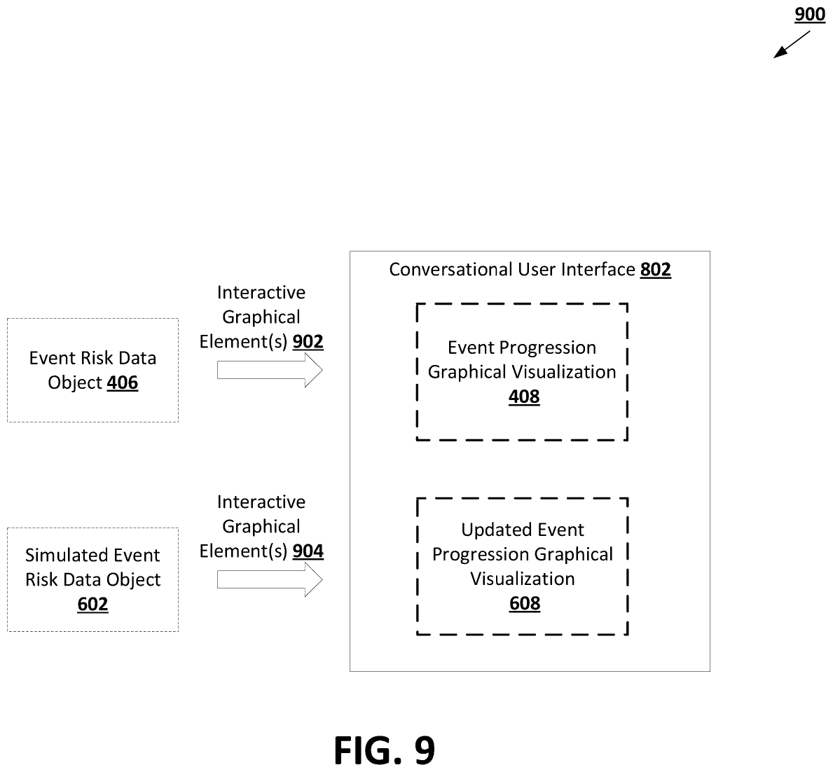

FIG. 9 illustrates an example user interface flow diagram 900 related to a conversational user interface, in accordance with one or more embodiments of the present disclosure. In one or more embodiments, the user interface flow diagram 900 includes the conversational user interface 802. In some embodiments, a rendering of the event progression graphical visualization 408 is initiated via the conversational user interface 802. In some embodiments, the rendering of the event progression graphical visualization 408 is based on the event risk data object 406. In some embodiments, one or more interactive graphical elements 902 associated with the event risk data object 406 may be rendered via the event progression graphical visualization 408. In some embodiments, the one or more interactive graphical elements 902 may include an event progression timeline chart that is based on the event risk data object 406 and/or one or more predefined event labels for one or more predefined events related to an event domain. Additionally or alternatively, in some embodiments, a rendering of the updated event progression graphical visualization 608 is initiated via the conversational user interface 802. In some embodiments, the rendering of the updated event progression graphical visualization 608 is based on the simulated event risk data object 602. In some embodiments, one or more interactive graphical elements 904 associated with the simulated event risk data object 602 may be rendered via the updated event progression graphical visualization 608. In some embodiments, the one or more interactive graphical elements 904 may include an updated event progression timeline chart that is based on the simulated event risk data object 602 and/or one or more predefined event labels for one or more predefined events related to an event domain.

In some embodiments, the conversational user interface 802 may be associated with a user interface pipeline. For example, in some embodiments, the computing system 101 may receive the user interface API request 812 and/or the event risk data object 406. In some embodiments, the event risk data object 406 may be generated using the entity feature dataset 404 and/or the event progression model 402 indicated by the user interface API request 812. In some embodiments, the user interface API request 812 may include a request to perform a predictive operation on the entity feature dataset 404 using the event progression model 402. The predictive operation may include machine learning to provide one or more predictions associated with predefined events that may occur for an entity identifier. In some embodiments, the predictive operation may include machine learning to provide one or more predictions associated with a potential health condition (e.g., a potential disease) for a patient entity. Additionally, in some embodiments, the computing system 101 may initiate, via the conversational user interface 802, a rendering of the event progression graphical visualization 408 that is based on the event risk data object 406.

In some embodiments, the computing system 101 may additionally or alternatively receive, via the conversational user interface 802, the natural language query 504. In some embodiments, the natural language query 504 may be included in a model API request for interacting with the event progression model 402. For example, in some embodiments, the structured data object 506 may be configured as a model API request for the event progression model 402 where the model API request is formatted according to the defined API 508 and the natural language query 504.

In some embodiments, the natural language query 504 may initiate, via the conversational user interface 802, a rendering of a model interaction dialog widget. In some embodiments, one or more user inputs to the model interaction dialog widget may be received via the conversational user interface 802. Each of the one or more user inputs may include a text segment. In some embodiments, the one or more user inputs may be aggregated to generate the natural language query 504. In some embodiments, in response to a first user input of the one or more user inputs, a prompt may be generated based on the first user input. Additionally, a rendering of the prompt may be initiated within the model interaction dialog widget via the conversational user interface 802. In some embodiments, the prompt may include a list of predetermined natural language queries that correspond to the first user input. Additionally or alternatively, each of the list of predetermined natural language queries may correspond to a model action for augmenting the performance of the event progression model 402. The model action may be associated with one or more attentional values and/or one or more modifications to entity feature dataset 404.

In some embodiments, the computing system 101 may additionally or alternatively receive the simulated event risk data object 602 from the event progression model 402. For example, the event progression model 402 may generate the simulated event risk data object 602 based on the entity feature dataset 404 and the natural language query 504. Additionally, in some embodiments, the computing system 101 may initiate, via the conversational user interface 802, a rendering of the updated event progression graphical visualization 608 that is based on the simulated risk data object 602.

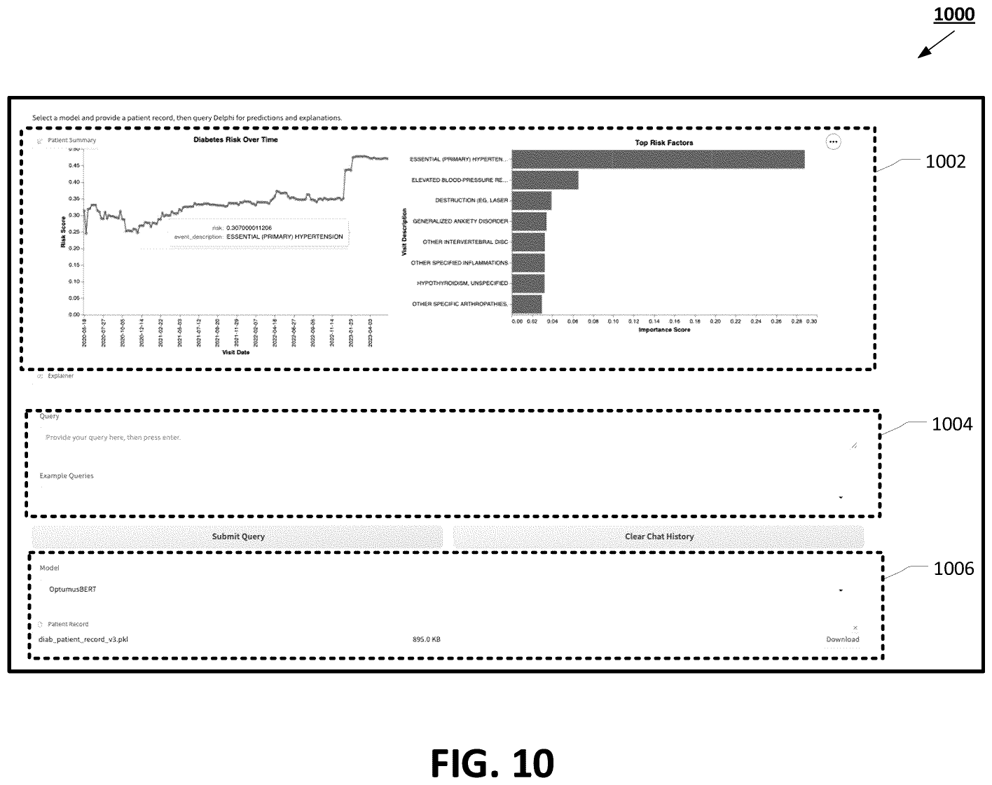

FIG. 10 illustrates an example conversational user interface 1000, in accordance with one or more embodiments of the present disclosure. In some embodiments, the conversational user interface 1000 corresponds to the conversational user interface 802. In some embodiments, the conversational user interface 1000 includes a user interface portion 1002 that renders an event progression graphical visualization such as, for example, the event progression graphical visualization 408 and/or the updated event progression graphical visualization 608. In some embodiments, the conversational user interface 1000 additionally or alternatively includes a user interface portion 1004 that provides an interactive graphical element for inputting a query and/or other query input data 810 such as, for example, the natural language query 504 and/or the query input data 810. In some embodiments, the user interface portion 1004 may render a model interaction dialog widget for inputting a query and/or other query input data 810 such as, for example, the natural language query 504 and/or the query input data 810. In some embodiments, the conversational user interface 1000 additionally or alternatively includes a user interface portion 1006 that provides an interactive graphical element for inputting a model and/or an entity feature dataset such as, for example, the entity feature dataset 404 and/or the event progression model 402.

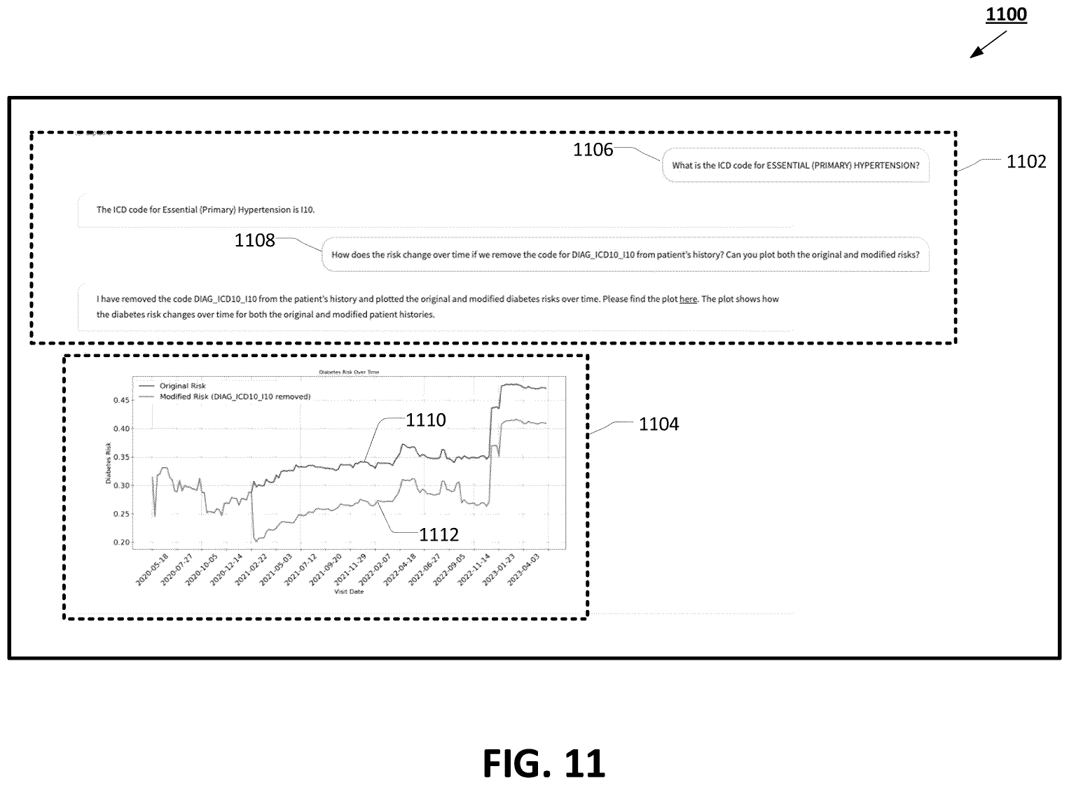

FIG. 11 illustrates an example conversational user interface 1100, in accordance with one or more embodiments of the present disclosure. In some embodiments, the conversational user interface 1100 corresponds to the conversational user interface 802. In some embodiments, the conversational user interface 1100 includes a user interface portion 1102 that provides an interactive graphical element for inputting a query and/or other query input data 810 such as, for example, the natural language query 504 and/or the query input data 810. In some embodiments, the user interface portion 1102 may render a model interaction dialog widget for inputting a query and/or other query input data 810 such as, for example, the natural language query 504 and/or the query input data 810. In some embodiments, the conversational user interface 1100 additionally or alternatively includes a user interface portion 1104 that renders an event progression graphical visualization such as, for example, the event progression graphical visualization 408 and/or the updated event progression graphical visualization 608. For example, the user interface portion 1104 may include an event progression timeline chart 1110 associated with the event progression graphical visualization 408 and an updated event progression timeline chart 1112 associated with the updated event progression graphical visualization 608. In some embodiments, the event progression timeline chart 1110 may be generated based on a first natural language query 1106 (e.g., “What is the ICD code for ESSENTIAL (PRIMARY) HYPERTENSION”). Additionally, the updated event progression timeline chart 1112 may be generated based on a second natural language query 1108 (e.g., “How does the risk change over time if we remove the code DIAG_ICD10_I10 from patient's history? may you plot both the original and modified risks?”).

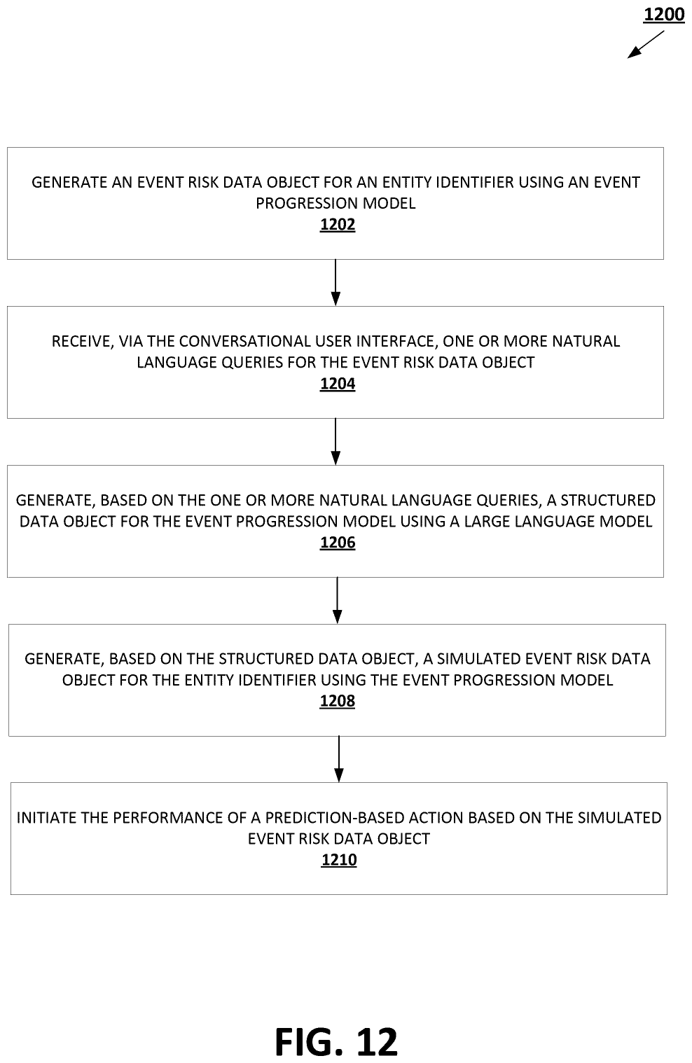

FIG. 12 is a flowchart diagram of an example process 1200 for providing a machine learning pipeline in accordance with some embodiments discussed herein. The process 1200 may be implemented by one or more computing devices, entities, and/or systems (e.g., the computing system 101 and/or the predictive computing entity 106) described herein. For example, via the various steps/operations of the process 1200, the computing system 101 may leverage improved machine learning techniques for a predictive model by utilizing a large language model. By doing so, the process 1200 enables predictive-based actions and/or the generation of an event progression graphical visualization that automatically adapts to a defined domain task provided via one or more natural language queries, while ensuring data quality for the predictive model in view of various data processing and/or machine learning rules.

FIG. 12 illustrates an example process 1200 for explanatory purposes. Although the example process 1200 depicts a particular sequence of steps/operations, the sequence may be altered without departing from the scope of the present disclosure. For example, some of the steps/operations depicted may be performed in parallel or in a different sequence that does not materially impact the function of the process 1200. In other examples, different components of an example device or system that implements the process 1200 may perform functions at substantially the same time or in a specific sequence.

In some embodiments, the process 1200 includes, at step/operation 1202, generating an event risk data object for an entity identifier using an event progression model. For example, the computing system 101 may generate, using an event progression model, an event risk data object for an entity identifier based on an entity feature dataset associated with the entity identifier.

In some embodiments, the process 1200 includes, at step/operation 1204, receiving, via the conversational user interface, one or more natural language queries for the event risk data object. For example, the computing system 101 may receive a natural language query for the event risk data object.

In some embodiments, the process 1200 includes, at step/operation 1206, generating, based on the one or more natural language queries, a structured data object for the event progression model using a large language model. For example, the computing system 101 may generate, by using a large language model, a structured data object from the natural language query that comprises a structured data format matching a defined API for the event progression model.

In some embodiments, the process 1200 includes, at step/operation 1208, generating, based on the structured data object, a simulated event risk data object for the entity identifier using the event progression model. For example, responsive to the structured data object, the computing system 101 may generate, using the event progression model, a simulated event risk data object for the entity identifier based on (i) a modification to the entity feature dataset and/or (ii) one or more attention values associated with the event risk data object.

In some embodiments, the process 1200 includes, at step/operation 1210, initiating the performance of a prediction-based action based on the simulated event risk data object. For example, the computing system 101 may initiate the performance of a prediction-based action based on the simulated event risk data object.

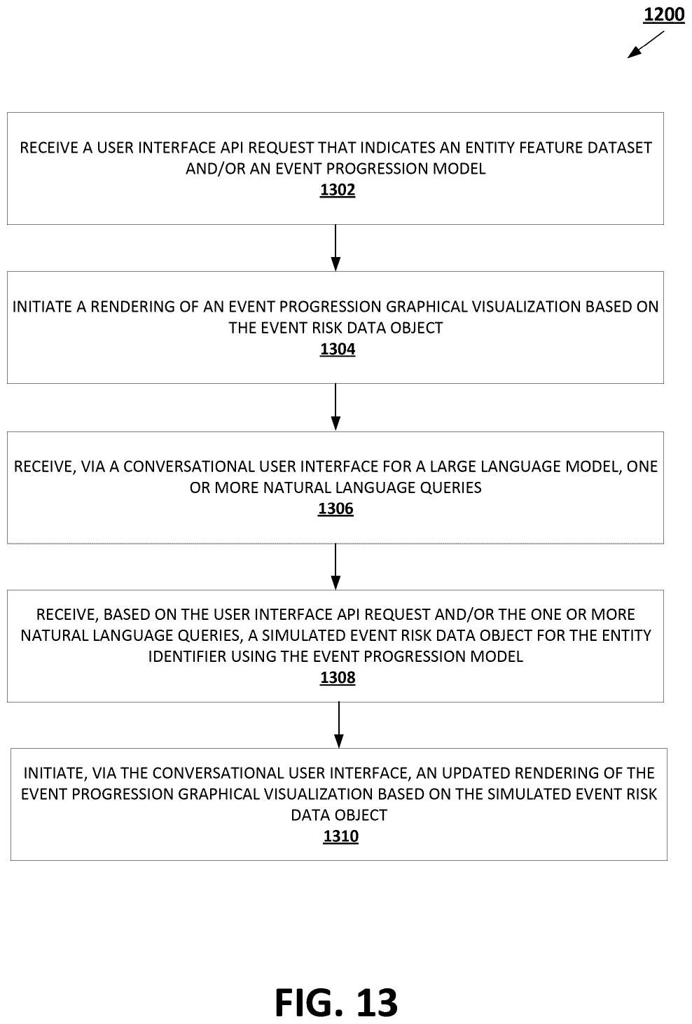

FIG. 13 is a flowchart diagram of an example process 1300 for providing a user interface pipeline in accordance with some embodiments discussed herein. The process 1300 may be implemented by one or more computing devices, entities, and/or systems (e.g., the computing system 101 and/or the predictive computing entity 106) described herein. For example, via the various steps/operations of the process 1300, the computing system 101 may leverage improved machine learning techniques for a predictive model by utilizing a large language model. By doing so, the process 1300 enables predictive-based actions and/or the generation of an event progression graphical visualization that automatically adapts to a defined domain task provided via one or more natural language queries, while ensuring data quality for the predictive model in view of various data processing and/or machine learning rules.

FIG. 13 illustrates an example process 1300 for explanatory purposes. Although the example process 1300 depicts a particular sequence of steps/operations, the sequence may be altered without departing from the scope of the present disclosure. For example, some of the steps/operations depicted may be performed in parallel or in a different sequence that does not materially impact the function of the process 1300. In other examples, different components of an example device or system that implements the process 1300 may perform functions at substantially the same time or in a specific sequence.

In some embodiments, the process 1300 includes, at step/operation 1302, receiving a user interface API request that indicates an entity feature dataset and/or an event progression model. For example, the computing system 101 may receive a user interface application programming interface (API) request that indicates (i) an entity feature dataset associated with the entity identifier and (ii) an event progression model.

In some embodiments, the process 1300 includes, at step/operation 1304 initiating a rendering of an event progression graphical visualization based on the event risk data object. For example, the computing system 101 may initiate, via a conversational user interface, a rendering of an event progression graphical visualization that is based on an event risk data object generated using (i) the entity feature dataset and (ii) the event progression model.

In some embodiments, the process 1300 includes, at step/operation 1306 receiving, via a conversational user interface for a large language model, one or more natural language queries. For example, the computing system 101 may receive, via a conversational user interface for a large language model, a natural language query.

In some embodiments, the process 1300 includes, at step/operation 1308 receiving, based on the user interface API request and/or the one or more natural language queries, a simulated event risk data object for the entity identifier using the event progression model. For example, the computing system 101 may receive a simulated event risk data object for the entity identifier based on (i) the user interface API request and (ii) the natural language query.

In some embodiments, the process 1300 includes, at step/operation 1310 initiating, via the conversational user interface, an updated rendering of the event progression graphical visualization based on the simulated event risk data object. For example, the computing system 101 may initiate, via the conversational user interface, an updated rendering of the event progression graphical visualization that is based on the simulated event risk data object

Some techniques of the present disclosure enable the generation of action outputs that may be performed to initiate one or more real world actions to achieve real-world effects. The data processing and machine learning techniques of the present disclosure may be used, applied, and/or otherwise leveraged to generate reliable data objects, which may help in the creation and provisioning of messages across computing entities, as well as other downstream tasks such as rendering of a visualization via a user interface. For instance, generative output, using some of the techniques of the present disclosure, may trigger the performance of actions at a client device, such as the display, transmission, and/or the like of data reflective of a event progression graphical visualization. In some embodiments, the event progression graphical visualization may trigger an alert via a user interface.

In some examples, the computing tasks may include actions that may be based on a defined domain task. A defined domain task may include any environment in which computing systems may be applied to generate an event progression graphical visualization and initiate the performance of computing tasks responsive to an event progression graphical visualization. These actions may cause real-world changes, for example, by controlling a hardware component of a user device or a server device, providing alerts, interactive actions, and/or the like. For instance, actions may include the initiation of automated instructions across and between devices, automated notifications, automated scheduling operations, automated precautionary actions, automated security actions, automated data processing actions, and/or the like.

### VI. CONCLUSION

Many modifications and other embodiments will come to mind to one skilled in the art to which the present disclosure pertains having the benefit of the teachings presented in the foregoing descriptions and the associated drawings. Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

### VII. EXAMPLES

Some embodiments of the present disclosure may be implemented by one or more computing devices, entities, and/or systems described herein to perform one or more example operations, such as those outlined below. The examples are provided for explanatory purposes. Although the examples outline a particular sequence of steps/operations, each sequence may be altered without departing from the scope of the present disclosure. For example, some of the steps/operations may be performed in parallel or in a different sequence that does not materially impact the function of the various examples. In other examples, different components of an example device or system that implements a particular example may perform functions at substantially the same time or in a specific sequence.

Moreover, although the examples may outline a system or computing entity with respect to one or more steps/operations, each step/operation may be performed by any one or combination of computing devices, entities, and/or systems described herein. For example, a computing system may include a single computing entity that is configured to perform all of the steps/operations of a particular example. In addition, or alternatively, a computing system may include multiple dedicated computing entities that are respectively configured to perform one or more of the steps/operations of a particular example. By way of example, the multiple dedicated computing entities may coordinate to perform all of the steps/operations of a particular example.

Example 1. A computer-implemented method comprising: generating, by one or more processors and using an event progression model, an event risk data object for an entity identifier based on an entity feature dataset associated with the entity identifier; receiving, by the one or more processors, a natural language query for the event risk data object; generating, by the one or more processors and using a large language model, a structured data object from the natural language query that comprises a structured data format associated with a defined API for the event progression model; generating, by the one or more processors and using the event progression model and the structured data object, a simulated event risk data object for the entity identifier based on (i) a modification to the entity feature dataset or (ii) one or more attention values associated with the event risk data object; and initiating, by the one or more processors, the performance of a prediction-based action based on the simulated event risk data object.

Example 2. The computer-implemented method of example 1, wherein generating the structured data object comprises: inputting the natural language query to a large language model to generate the structured data object, wherein the structured data object is generated by translating the natural language query into the structured data object using the large language model.

Example 3. The computer-implemented method of any of the above examples, wherein the structured data object comprises a set of computer instructions for interacting with the event progression model.

Example 4. The computer-implemented method of any of the above examples, wherein generating the structured data object comprises: generating the structured data object by executing an REPL loop based on the natural language query.

Example 5. The computer-implemented method of any of the above examples, wherein generating the simulated event risk data object comprises: removing one or more features from the entity feature dataset based on the structured data object; and generating an event risk score for the entity identifier based on a sequence of removal of the one or more features from the entity feature dataset.

Example 6. The computer-implemented method of any of the above examples, wherein generating the simulated event risk data object comprises: modifying a particular feature from the entity feature dataset in response to a determination, based on the structured data object, that a modification to the particular feature results in a greatest change to the event risk data object as compared to one or more other features from the entity feature dataset.

Example 7. The computer-implemented method of any of the above examples, wherein generating the simulated event risk data object comprises generating a simulated entity feature dataset by adding a simulated event feature to the entity feature dataset based on the structured data object; and generating an event risk score for the entity identifier based on the simulated entity feature dataset.

Example 8. The computer-implemented method of any of the above examples, wherein generating the simulated event risk data object comprises: determining importance of respective features of the entity feature dataset based on the structured data object; generating the one or more attention values based on the importance of respective features; generating a weighted entity feature dataset by weighting the entity feature dataset based on the one or more attention values; and generating, using the event progression model, the simulated event risk data object based on the weighted entity feature dataset.

Example 9. The computer-implemented method of any of the above examples, wherein generating the simulated event risk data object comprises: generating an event risk score for respective features of the entity feature dataset based on the structured data object; and generating the simulated event risk data object based on the event risk score.

Example 10. The computer-implemented method of claim of any of the above examples, wherein generating the simulated event risk data object comprises: generating a modified entity feature dataset by modifying one or more features of the entity feature dataset based on the structured data object; and inputting the modified entity feature dataset to the event progression model to generate the simulated risk data object.

Example 11. A computing system comprising memory and one or more processors communicatively coupled to the memory, the one or more processors configured to: generate, using an event progression model, an event risk data object for an entity identifier based on an entity feature dataset associated with the entity identifier; receive a natural language query for the event risk data object; generate, using a large language model, a structured data object from the natural language query that comprises a structured data format associated with a defined API for the event progression model; generate, using the event progression model and the structured data object, a simulated event risk data object for the entity identifier based on (i) a modification to the entity feature dataset or (ii) one or more attention values associated with the event risk data object; and initiate the performance of a prediction-based action based on the simulated event risk data object.

Example 12. The computing system of example 11, wherein the one or more processors are further caused to: input the natural language query to a large language model to generate the structured data object, wherein the structured data object is generated by translating the natural language query into the structured data object using the large language model.

Example 13. The computing system of examples 11 to 12, wherein the one or more processors are further caused to: configure the structured data object as a set of computer instructions for interacting with the event progression model.

Example 14. The computing system of examples 11 to 13, wherein the one or more processors are further caused to: generate the structured data object by executing an REPL loop based on the natural language query.

Example 15. The computing system of examples 11 to 14, wherein the one or more processors are further caused to: remove one or more features from the entity feature dataset based on the structured data object; and generate an event risk score for the entity identifier based on a sequence of removal of the one or more features from the entity feature dataset.

Example 16. The computing system of examples 11 to 15, wherein the one or more processors are further caused to: modify a particular feature from the entity feature dataset in response to a determination, based on the structured data object, that a modification to the particular feature results in a greatest change to the event risk data object as compared to one or more other features from the entity feature dataset.

Example 17. The computing system of examples 11 to 16, wherein the one or more processors are further caused to: generate a simulated entity feature dataset by adding a simulated event feature to the entity feature dataset based on the structured data object; and generate an event risk score for the entity identifier based on the simulated entity feature dataset.

Example 18. The computing system of examples 11-17, wherein the one or more processors are further caused to: determine importance of respective features of the entity feature dataset based on the structured data object; generate a weighted entity feature dataset by weighting the entity feature dataset based on the one or more attention values; and generate, using the event progression model, the simulated event risk data object based on the weighted entity feature dataset.

Example 19. The computing system of examples 11-18, wherein the one or more processors are further caused to: generate an event risk score for respective features of the entity feature dataset based on the structured data object; and generate the simulated event risk data object based on the event risk score.

Example 20. One or more non-transitory computer-readable storage media including instructions that, when executed by one or more processors, cause the one or more processors to: generate, using an event progression model, an event risk data object for an entity identifier based on an entity feature dataset associated with the entity identifier; receive a natural language query for the event risk data object; generate, using a large language model, a structured data object from the natural language query that comprises a structured data format associated with a defined application programming interface (API) for the event progression model; generate, using the event progression model and the structured data object, a simulated event risk data object for the entity identifier based on (i) a modification to the entity feature dataset or (ii) one or more attention values associated with the event risk data object; and initiate the performance of a prediction-based action based on the simulated event risk data object.

Example 21: The computer-implemented method of example 1, wherein the event progression model is a supervised machine learning model and the method further comprises receiving training data for the event progression model and training the event progression model using the training data.

Example 22: The computer-implemented method of example 1, wherein the training is performed by the one or more processors.

Example 23: The computer-implemented method of example 1, wherein: the one or more processors are included in a first computing entity; and the training is performed by one or more other processors included in a second computing entity.

1. A computer-implemented method comprising:
generating, by one or more processors and using an event progression model, an event risk data object for an entity identifier based on an entity feature dataset associated with the entity identifier;
receiving, by the one or more processors, a natural language query for the event risk data object;
generating, by the one or more processors and using a large language model, a structured data object from the natural language query that comprises a structured data format associated with a defined application programming interface (API) for the event progression model;
generating, by the one or more processors and using the event progression model and the structured data object, a simulated event risk data object for the entity identifier based on (i) a modification to the entity feature dataset or (ii) one or more attention values associated with the event risk data object; and
initiating, by the one or more processors, the performance of a prediction-based action based on the simulated event risk data object.

2. The computer-implemented method of claim 1, wherein generating the structured data object comprises:
inputting the natural language query to a large language model to generate the structured data object, wherein the structured data object is generated by translating the natural language query into the structured data object using the large language model.

3. The computer-implemented method of claim 1, wherein the structured data object comprises a set of computer instructions for interacting with the event progression model.

4. The computer-implemented method of claim 1, wherein generating the structured data object comprises:
generating the structured data object by executing a read-evaluate-print (REPL) loop based on the natural language query.

5. The computer-implemented method of claim 1, wherein generating the simulated event risk data object comprises:
removing one or more features from the entity feature dataset based on the structured data object; and
generating an event risk score for the entity identifier based on a sequence of removal of the one or more features from the entity feature dataset.

6. The computer-implemented method of claim 1, wherein generating the simulated event risk data object comprises:
modifying a particular feature from the entity feature dataset in response to a determination, based on the structured data object, that a modification to the particular feature results in a greatest change to the event risk data object as compared to one or more other features from the entity feature dataset.

7. The computer-implemented method of claim 1, wherein generating the simulated event risk data object comprises:
generating a simulated entity feature dataset by adding a simulated event feature to the entity feature dataset based on the structured data object; and
generating an event risk score for the entity identifier based on the simulated entity feature dataset.

8. The computer-implemented method of claim 1, wherein generating the simulated event risk data object comprises:
determining importance of respective features of the entity feature dataset based on the structured data object;
generating the one or more attention values based on the importance of respective features;
generating a weighted entity feature dataset by weighting the entity feature dataset based on the one or more attention values; and
generating, using the event progression model, the simulated event risk data object based on the weighted entity feature dataset.

9. The computer-implemented method of claim 1, wherein generating the simulated event risk data object comprises:
generating an event risk score for respective features of the entity feature dataset based on the structured data object; and
generating the simulated event risk data object based on the event risk score.

10. The computer-implemented method of claim 1, wherein generating the simulated event risk data object comprises:
generating a modified entity feature dataset by modifying one or more features of the entity feature dataset based on the structured data object; and
inputting the modified entity feature dataset to the event progression model to generate the simulated risk data object.

11. A computing system comprising memory and one or more processors communicatively coupled to the memory, the one or more processors configured to:
generate, using an event progression model, an event risk data object for an entity identifier based on an entity feature dataset associated with the entity identifier;
receive a natural language query for the event risk data object;
generate, using a large language model, a structured data object from the natural language query that comprises a structured data format associated with a defined application programming interface (API) for the event progression model;
generate, using the event progression model and the structured data object, a simulated event risk data object for the entity identifier based on (i) a modification to the entity feature dataset or (ii) one or more attention values associated with the event risk data object; and
initiate the performance of a prediction-based action based on the simulated event risk data object.

12. The computing system of claim 11, wherein the one or more processors are further caused to:
input the natural language query to a large language model to generate the structured data object, wherein the structured data object is generated by translating the natural language query into the structured data object using the large language model.

13. The computing system of claim 11, wherein the one or more processors are further caused to:
configure the structured data object as a set of computer instructions for interacting with the event progression model.

14. The computing system of claim 11, wherein the one or more processors are further caused to:
generate the structured data object by executing a read-evaluate-print (REPL) loop based on the natural language query.

15. The computing system of claim 11, wherein the one or more processors are further caused to:
remove one or more features from the entity feature dataset based on the structured data object; and
generate an event risk score for the entity identifier based on a sequence of removal of the one or more features from the entity feature dataset.

16. The computing system of claim 11, wherein the one or more processors are further caused to:
modify a particular feature from the entity feature dataset in response to a determination, based on the structured data object, that a modification to the particular feature results in a greatest change to the event risk data object as compared to one or more other features from the entity feature dataset.

17. The computing system of claim 11, wherein the one or more processors are further caused to:
generate a simulated entity feature dataset by adding a simulated event feature to the entity feature dataset based on the structured data object; and
generate an event risk score for the entity identifier based on the simulated entity feature dataset.

18. The computing system of claim 11, wherein the one or more processors are further caused to:
determine importance of respective features of the entity feature dataset based on the structured data object;
generate a weighted entity feature dataset by weighting the entity feature dataset based on the one or more attention values; and
generate, using the event progression model, the simulated event risk data object based on the weighted entity feature dataset.

19. The computing system of claim 11, wherein the one or more processors are further caused to:
generate an event risk score for respective features of the entity feature dataset based on the structured data object; and
generate the simulated event risk data object based on the event risk score.

20. One or more non-transitory computer-readable storage media including instructions that, when executed by one or more processors, cause the one or more processors to:
generate, using an event progression model, an event risk data object for an entity identifier based on an entity feature dataset associated with the entity identifier;
receive a natural language query for the event risk data object;
generate, using a large language model, a structured data object from the natural language query that comprises a structured data format associated with a defined application programming interface (API) for the event progression model;
generate, using the event progression model and the structured data object, a simulated event risk data object for the entity identifier based on (i) a modification to the entity feature dataset or (ii) one or more attention values associated with the event risk data object; and
initiate the performance of a prediction-based action based on the simulated event risk data object.
